(19) United States
(12) Patent Application Publication
(10) Pub. No.: US 2026/0270690 A1
(43) Pub. Date: Sep. 10, 2026

(54) COMMUNICATION METHOD OBFUSCATING MULTIPLE PRIVACY PARAMETERS

(71) Applicant: CANON KABUSHIKI KAISHA, Tokyo (JP)

(72) Inventors: Julien SEVIN, SAINT AUBIN DU CORMIER (FR); Stéphane BARON, LE RHEU (FR); Patrice NEZOU, LIFFRE (FR)

(21) Appl. No.: 19/162,872

(22) PCT Filed: Mar. 8, 2024
(86) PCT No.: PCT/EP2024/056267

§ 371 Date: Sep. 5, 2025

(30) Foreign Application Priority Data
Mar. 10, 2023 (GB) 2303578.5
Jul. 4, 2023 (GB) 2310254.4
Nov. 9, 2023 (GB) 2317214.1

(51) Int. Cl. H04W 12/02; H04W 12/03

(52) U.S. Cl. CPC H04W 12/02; H04W 12/03

(57) ABSTRACT

The invention relates to communication methods that obfuscate PE parameters at reasonable implementation costs. Some PE parameters can be reset with uncorrelated values without impact on data transmission, while other PE parameters cannot be reset. A first station executes a pseudo-random function shared with a second station, with a shared key and a current value of a shared generation parameter as inputs, to obtain a result value made of a bit sequence. The result value is split into chunks. A first chunk forms a new reset-based PE parameter value, uncorrelated with a previous value. A second chunk forms a shared mask for a mask-based PE parameter. The mask-based PE parameter is XORed with the shared mask in order to obtain an encoded PE parameter that obfuscate the current parameter value. The latter and the new reset-based PE parameter value are transmitted within a frame sent to the second station.

### FIELD OF THE INVENTION

The present invention relates to wireless communications and more specifically to user privacy during wireless communications.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The 802.11 family of standards adopted by the Institute of Electrical and Electronics Engineers (IEEE) provides a great number of mechanisms for wireless communications between stations.

Today, the evolution of wireless systems has brought privacy concerns at the forefront, driven by user demand and requirements of the General Data Protection Regulation (GDPR). The global wireless industry is faced with the growing need to protect users' personally identifiable information from increasingly sophisticated user tracking and user profiling activities, while continuing to improve wireless services and the user experience.

The Personally Identifiable Information (PII) corresponds to any data that identifies an individual or from which identity or contact information of an individual can be derived. A device's MAC address is an example of PII.

A dedicated task group 802.11bi has been initiated in 2019 to address those privacy concerns. Its objective is to specify Privacy Enhancements (PE) features to be added in the current standard to increase privacy. Some of the PE features are relative to the obfuscation of multiple identified PII, known as transmitted PE parameters, contained in the frames exchanged by the stations (STA). The obfuscation consisting in performing a simultaneous change of the transmitted PE parameters (which are transmitted in clear in the frames) by the stations, to uncorrelated new values (with the previous ones) without any loss of connection.

### SUMMARY OF THE INVENTION

For instance, co-pending application PCT/EP2023/050224, entitled “METHOD FOR CHANGING THE VALUE OF ONE OR MORE PRIVACY PARAMETERS OF STATIONS WITHIN A BASIC SERVICE SET”, provides obfuscation mechanisms to obfuscate multiple PE parameters with low implementation cost. New uncorrelated values are randomly generated at once for the multiple PE parameters, by executing in parallel the same shared pseudo-random function (PRF) locally at the AP station and at one or more non-AP stations. Then, the various stations change the transmitted PE parameters with the computed new uncorrelated values.

The drawback of the mechanism is that the transmitted PE parameters are necessarily reset by the generated uncorrelated (and randomized) values, hence losing any underlying continuity with the previous values or original setting, as required to avoid any impact on data transmission. Indeed, the previous values or original setting is sometimes used to initiate and launch specific mechanism. This is for instance the case for PE parameters such as the packet number PN, the transport identifier TID or the Beacon Interval.

Switching from a reset of the transmitted PE parameters to a mere obfuscating thereof, by masking for example, would be preferable.

XOR masking of the two PE parameters Packet Number (PN) and Traffic Identifier (TID) without reset has been proposed. A same hash function is locally performed in parallel at the AP station and the non-AP station or stations to obtain two masks to be XORed to the PN and TID values. The frames finally exchanged only carry the masked PN and TID values.

However, additional obfuscation procedures have to be implemented to obfuscate the others transmitted PE parameters, hence increasing strongly the implementation cost.

Also, due to the masking, decoding is required at the destination/receiver station to retrieve the unmasked (or decoded) PN or TID value.

There is thus a need for new communication methods that obfuscate the PE parameters at reasonable implementation costs.

In this context, the invention provides a method of communication in wireless network, comprising, at a first station:
obtaining a function that is shared with a second station;
executing the shared function with a current value of at least one shared input, to obtain a result value;
obtaining a first privacy parameter value as a first chunk of the result value and an encoding parameter value as a second chunk of the result value;
encoding a second privacy parameter value using the encoding parameter value; and
transmitting to the second station a frame comprising the first privacy parameter value and the encoded second privacy parameter value.

The first and second privacy parameters are separate. They may correspond to any of the above transmitted PE parameters or Personally Identifiable Information (PII) that allows an identification or tracking of the communicating stations. These include the Client Privacy Enhancements, CPE, features related to a non-AP station as well as the BSS Privacy Enhancements, BPE, features related to the AP station. The first privacy parameter value replaces an old one simultaneously at both stations. Such type of privacy parameter is also named reset-based privacy (or PE) parameter in this document.

Similarly, the encoding parameter value (such as a binary mask) replaces an old one (to encode the second privacy parameter values) simultaneously at both stations. This is to avoid any impact on the data transmission between the stations due to the original setting or continuity of the second privacy parameter. Such type of privacy parameter is also named reset-free or mask-based encoding privacy (or PE) parameter in this document.

The shared input or inputs preferably include a value varying over time, meaning a shared parameter whose value is known by both stations, wherein the value of the parameter is different at two different times when the procedure according to the invention is executed again for the same privacy parameters. As described below, the shared parameter, also referred to as shared generation parameter as it contributes to the generation of the result value, may be a time, a date, a counter, a EUI of the target station (such as a MAC address that is changed over time using the mechanisms of the invention). By “current value of the at least one shared input” it is meant the value of the input or inputs including the shared generation parameter at the time at which the procedure is launched.

The shared input or inputs may include a shared key that is known by both stations. Its value can be dedicated to the non-AP station (i.e., two non-AP stations have two distinct shared keys), or be the same for a subgroup of non-AP stations associated with the AP station or to all the non-AP stations associated with the AP station. Also, its value may be common for the BSS (i.e., all the stations of the BSS) when e.g., the privacy parameters (BPE parameters) relate to the AP station (hence the BSS).

The share key and the shared generation parameter may form two distinct inputs to the shared function or may be merged or concatenated as a single input to the shared function.

The chunk of the result value may be seen as a binary subpart of the result value.

Thanks to the proposed method, the encoding parameter value (e.g., a mask for the second privacy parameter) and the new value for a first privacy parameter are generated at once through the execution of the shared function.

A single generation mechanism is therefore used for the purpose of obfuscation with reset and obfuscation without reset of the values. This approach advantageously limits the implementation or computation costs.

Correspondingly, a method of communication in wireless network, at a second station, comprises:
obtaining a function that is shared with a first station;
executing the shared function with a current value of at least one shared input, to obtain a result value;
obtaining a first privacy parameter value as a first chunk of the result value and an encoding parameter value as a second chunk of the result value;
receiving from the first station a frame comprising the first privacy parameter value and an encoded second privacy parameter value;
decoding, using the encoding parameter value, the encoded second privacy parameter value to obtain a second privacy parameter value.

In that way, the second station is able to keep synchronization of the second privacy parameter with the first station, although its obfuscation without reset evolves over time. The same advantages related to limited implementation costs are achieved.

The function of each possible privacy parameter in the processing by the second station of a frame transmitted by the first station directly derives from the nature of the privacy parameter as known by the skilled person. Exemplary privacy parameters are provided below. As an example, the first privacy parameter such as a MAC address may help discarding a frame if not addressed to the second station. In that case, the second station may compare the obtained first privacy parameter value with a first local value corresponding to the same privacy parameter (e.g., MAC address).

Optional features of the invention are defined below with reference to a method, while they can be transposed into device features. The various embodiments below can be combined, unless obvious incompatibility.

In some embodiments, encoding or decoding includes masking or unmasking, such as XORing, the second privacy parameter or encoded second privacy parameter respectively with the encoding parameter value. In that case, the encoding parameter value may be a binary mask to be XORed with the second privacy parameter value for encoding or with the encoded second privacy parameter for decoding. This approach defines a masking of the second privacy parameter for use in the exchanged frame. Masking, such as XORing, advantageously requires low resources.

Alternatives to masking may include adding or subtracting the encoding parameter value as an offset or an addition operation to the second or encoded second privacy parameter. A variant may include binary rotating the bits of the privacy parameter based on the encoding parameter value. In these alternatives, the encoding parameter value may be a random value.

In some embodiments, the same encoding parameter value is used to encode another privacy parameter value than the second privacy parameter value or to decode another encoded privacy parameter value than the encoded second privacy parameter value. By using the same mask to mask or unmask different PE parameters, it is possible to reduce computation costs, in particular the length of the output of the share function.

In some embodiments, multiple encoding parameter values are obtained as multiple chunks of the result value. They may be used to obfuscate the same second privacy parameter. By operating with multiple masks to obfuscate a PE parameter, its privacy is increased. For instance, in a context of Multi-Link Operations (MLO) as specified in 802.11be, the multiple encoding parameter values may be assigned to multiple respective links (links enabled between two MLDs to which the first and second stations are affiliated). In such a case, when the CPE client operates the obfuscation, it selects the encoding parameter value assigned to the link through the frame to be obfuscated will be transmitted, to encode the second privacy parameter. In other words, encoding the second privacy parameter value includes selecting one of the multiple encoding parameter values that is assigned to a link on which the frame is to be transmitted and encoding the second privacy parameter value using the selected encoding parameter value.

The reverse operation may be made at the receiving side. In other words, decoding the encoded second privacy parameter value includes selecting one of the multiple encoding parameter values that is assigned to a link on which the frame is received and decoding the encoded second privacy parameter value using the selected encoding parameter value.

In some embodiments, the method further comprises obtaining multiple first privacy parameter values and/or multiple encoding parameter values as multiple chunks of the result value. A large number of encoding parameter values (e.g., to mask multiple PE parameters) and a large number of new values for other PE parameters may thus be generated at once through the single execution of the shared function, without additional computation costs.

In that case, the frame may comprise the multiple first privacy parameter values and/or multiple second privacy parameter values encoded using the multiple encoding parameter values respectively. Plural PE parameters, preferably all, within the exchanged frame are therefore obfuscated.

In some embodiments, the chunks are disjoint within the result value. This applies to the first and second chunks as well as the multiple chunks. Alternatively, the chunks may overlap in order to reduce the length of the (binary) result value from the shared function.

In some embodiments, the method includes executing the shared function a second time based on another current value of at least a second shared input, to obtain another first privacy parameter value and another encoding parameter value. In that way where multiple executions (more than two executions is possible) are performed over time, privacy is protected over time. This may concern the same privacy parameters over time (in which case the second shared input is based on the same parameter evolving over time as the shared input mentioned above), or may concern different privacy parameters, such as CPE parameters at a time and BPE parameters at the second time (the second shared input may thus involve a different evolving parameter).

According to embodiments protecting the same PE parameter over time, the other first privacy parameter value and the first privacy parameter value relate to the same privacy parameter associated with one of the stations. That means a new value (the other first privacy parameter value) is obtained for the PE parameter considered, which replaces the previous one (the first privacy parameter value) within the subsequent frame exchanges, up to a further new value to be obtained.

Similarly, the other encoding parameter value may be used to encode another value or decode another encoded value of the same privacy parameter as the second privacy parameter value. That means the mask (encoding parameter value) evolves over time to modify the encoding of the successive values of the privacy parameter concerned.

In specific embodiments, the other current value of the second shared input includes the first privacy parameter value. A cascading is therefore operated where the subsequent execution of the shared function is based on a chunk of the result value of the former execution. This ensures one input of the shared function evolves over time. In that case, the at least one second shared input is the same as the at least one shared input. As an example, the MAC address of one station may be considered as the first privacy parameter value that evolves over multiple executions of the shared function. In that case, the at least one shared input includes a MAC address of one of the stations.

According to embodiments, the other first privacy parameter value relates to a privacy parameter associated with one of the stations and the first privacy parameter value relates to a privacy parameter associated with the other station. This illustrates that, at the same station, the PE parameters of both stations evolve over the multiple executions of the shared function. As an example, a MAC address of one station as “other first privacy parameter value” may then be set in the receiver address field of a frame, while a MAC address of the other station as “first privacy parameter value” may be set in the transmitter address field of a frame, be it the same frame or a different frame.

In some embodiments, the at least one shared input includes a key shared with the second station and a generation parameter shared with the second station and varying over time. The shared key may form a first input to the shared function. The shared key is a shared secret allowing anonymity. The shared generation parameter may form a second input to the shared function. The shared generation parameter avoids or reduces traceability because it evolves over time. The shared function may or not have an additional input, e.g., a text string specific to the operation to make. Alternatively, the shared key and the shared generation parameter may be combined, merged or concatenated within a single input to the shared function. Other parameters may be used in combination or replacement.

In some embodiments, the first privacy parameter or parameters are one or more from:
one or more Extended Unique Identifiers, EUIs, of the stations,
one or more MAC addresses of the stations,
a MAC address of a Multi-Link Device, MLD, to which one of the stations is affiliated,
a sequence number used by the stations to uniquely identify a new MSDU, A-MSDU, or MMPDU,
an uplink sequence number used by the stations to uniquely identify a new uplink MSDU, A-MSDU, or MMPDU,
a downlink sequence number used by the stations to uniquely identify a new unicast downlink MSDU, A-MSDU, or MMPDU,
a group sequence number used by the stations to uniquely identify a new broadcast or multicast downlink MSDU, A-MSDU, or MMPDU,
an association identifier, AID, of one of the stations to uniquely identify the one station within a BSS of the stations,
a scrambler seed used by the stations to initialize a local scrambler scrambling transmit data and/or descrambling receive data,
an uplink scrambler seed used by the stations to initialize a local scrambler scrambling transmit uplink data and/or descrambling receive uplink data,
a downlink scrambler seed used by the stations to initialize a local scrambler scrambling transmit unicast downlink data and/or descrambling receive unicast downlink data,
a group scrambler seed used by the stations to initialize a local scrambler scrambling transmit broadcast or multicast downlink data and/or descrambling receive broadcast or multicast downlink data,
a beacon interval defining the time interval between two consecutive target beacon transmission times, TBTTs,
a BSS color used as a numerical identifier of a BSS of the stations,
a Timing Synchronization Function (TSF) timer used to synchronize (all) stations within a BSS of the stations.

In other embodiments that may be combined, the second privacy parameter or parameters are one or more from:
a sequence number used by the stations to uniquely identify a new MSDU, A-MSDU, or MMPDU,
an uplink sequence number used by the stations to uniquely identify a new uplink MSDU, A-MSDU, or MMPDU,
a downlink sequence number used by the stations to uniquely identify a new unicast downlink MSDU, A-MSDU, or MMPDU,
a group sequence number used by the stations to uniquely identify a new broadcast or multicast downlink MSDU, A-MSDU, or MMPDU,
a packet number used by the stations to uniquely identify a new frame, an uplink packet number used by the stations to uniquely identify a new uplink frame,
a downlink packet number used by the stations to uniquely identify a new unicast downlink frame,
a group packet number used by the stations to uniquely identify a new broadcast or multicast downlink frame,
an uplink Traffic Identifier, TID, used by the stations to provide Quality of Services to an uplink frame,
a downlink Traffic Identifier, TID, used by the stations to provide Quality of Services to a downlink frame,
a beacon interval defining the time interval between two consecutive target beacon transmission times, TBTTs.

In some embodiments, the first privacy parameter value is a MAC address of the first station and the frame comprises a transmitter address field set to the first privacy parameter value and a receiver address field set to a MAC address of the second station. The obfuscating hence applies to the PE parameters of the transmitting (first) station.

In alternative embodiments, the first privacy parameter value is a MAC address of the second station and the frame comprises a receiver address field set to the first privacy parameter value and a transmitter address field set to a MAC address of the first station. The obfuscating hence applies to the PE parameters of the receiver (second) station.

In some embodiments, the first station is a non-AP station and the second station is an AP station.

In alternative embodiments, the first station is an AP station and the second station is a non-AP station.

Correlatively, the invention also provides a wireless communication device comprising at least one microprocessor configured to execute any communication method as defined above.

Another aspect of the invention relates to a non-transitory computer-readable medium storing a program for causing a computer to execute any communication method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

Some embodiments of the present invention are illustrated by way of example, and not by way of limitation, in the figures of the accompanying drawings, in which like reference numerals refer to similar elements and in which:

FIG. 1 illustrates an example of a network system in which embodiments of the invention may be used;

FIGS. 2a and 2b illustrate, using flowcharts, general steps of a communication method obfuscating a first privacy parameter by a reset-based obfuscation operation and a second privacy parameter by an encoding obfuscation operation in a frame transmitted by a first PE STA and received by a second PE STA, according to one or several embodiments of the invention;

FIG. 3a illustrates a first ordered list of eleven CPE parameters obfuscated through the Client ERCM procedure, according to one or several embodiments of the invention;

FIG. 3b illustrates a second ordered list of CPE parameters obfuscated through the Client ERCM procedure, according to one or several embodiments of the invention;

FIG. 4 illustrates a third ordered list that is shortened compared to FIG. 3a, made of six CPE parameters obfuscated through the Client ERCM procedure, according to one or several embodiments of the invention;

FIG. 5 illustrates an ordered list of twelve BPE parameters obfuscated through the BSS ERCM procedure, according to one or several embodiments of the invention;

FIG. 6a illustrates, using a flowchart, exemplary steps performed by CPE stations for which a Client ERCM procedure operates on a list of CPE Parameters, according to embodiments of the invention;

FIG. 6b illustrates, using a flowchart, exemplary steps performed by BPE stations for which a BSS ERCM procedure operates on a list of BPE Parameters, according to embodiments of the invention;

FIGS. 7a and 7b illustrate, using flowcharts, a communication method frame between two PE stations operating with an ERCM procedure, according to one or several embodiments of the invention;

FIG. 8 illustrates, using frame exchanges, multiple obfuscations over time, according to embodiments of the invention; and

FIG. 9 illustrates an example of a communication device of a wireless network, configured to implement at least one embodiment of the present invention.

### DESCRIPTION OF SOME EMBODIMENTS

The IEEE 802.11 working group has proposed a procedure to limit the risk of a user being traced, which consists in dynamically modifying the MAC address of the user device. This mechanism is known as the Randomized and Changing MAC (RCM) procedure,

Changing only the MAC addresses is a first step to improve the privacy but it is often not sufficient. Other elements transmitted in the frames and identifying an individual or from which identity or contact information of the individual can be derived can also be dynamically modified in order to be not identifiable and/or not trackable. Such elements of privacy are also known as Personally Identifiable Information (PII) or privacy parameters/identifiers or transmitted PE parameters or OTA (Over-The-Air) parameters/identifiers. All these expressions can be used interchangeably below. Furthermore, CPE and BPE parameters specifically refer to PE parameters associated with a non-AP station and with the AP station, respectively.

Some of these transmitted PE parameters can be reset with new values without impact on conventional processing. However, other transmitted PE parameters cannot be reset due to original setting that would be lost or to required continuity or stability over the multiple frames exchanged, that are needed to initiate and launch specific mechanism or at least to avoid misprocessing by conventional mechanisms.

This is the case of the Packet Number (PN) and Traffic Identifier (TID) and Beacon Interval conveyed in the frames. XOR masking of these two PE parameters Packet Number (PN) and Traffic Identifier (TID) has been proposed using masks obtained through the same hash function performed in parallel at the AP station and the non-AP station or stations. The mask-based obfuscation however increases the implementation cost at both the emitter (to perform XOR masking to obfuscate PN or TID) and the receiver (to inverse mask the received PN and TID).

Cohabitation between reset-based obfuscation and reset-free obfuscation (also named mask-based obfuscation) at acceptable implementation costs is provided in a new way.

Two stations share data such as a key and a generation parameter and also share a function, e.g., a Pseudo Random Function. The generation parameter evolves over time. This may be the MAC address of one of the stations. Usually, one of the stations is an access point (AP) station while the other is a non-AP station belonging to a BSS managed by the AP station.

Each station executes the shared function with a shared input or inputs, that may be the shared key and a current value of the shared generation parameter, to obtain the same result value or generation output. This may take the form a binary sequence.

A first chunk, or subpart, of the result value is used as a first privacy parameter value, i.e., forms the new value for one of the privacy parameters, hence a reset-based obfuscated one. As the two stations obtain the same result value, they also obtain the same first privacy parameter value, hence it is shared.

A second chunk of the result value is used as an encoding parameter value for another privacy parameter. This is for example a mask dedicated to the other privacy parameter. As the two stations obtain the same result value, they also obtain the same encoding parameter value, hence it is shared.

Hence at the emitter, a second privacy parameter value is encoded (e.g., masked) using the encoding parameter value. This is a mask-based obfuscated privacy parameter to be used for further communication.

Those two obfuscated privacy parameters can then be used: a frame is exchanged that comprises the first privacy parameter value and the encoded second privacy parameter value.

At the receiver, the encoded second privacy parameter value is decoded, using the (shared) encoding parameter value to retrieve the second privacy parameter value. This ensures the two stations are aware of the same second privacy parameter value, while the value has been obfuscated for communication without any reset.

Thanks to this approach, the same and single execution of the shared function provides both the reset value(s) for one or more reset-based obfuscated privacy parameters and the encoding value(s) (masks) for one or more mask-based obfuscated privacy parameters.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals, i.e., wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

While the examples and embodiments are described in the context of Wi-Fi® networks, the invention may be used in any type of wireless networks, like, for example, mobile phone cellular networks that implement very similar mechanisms.

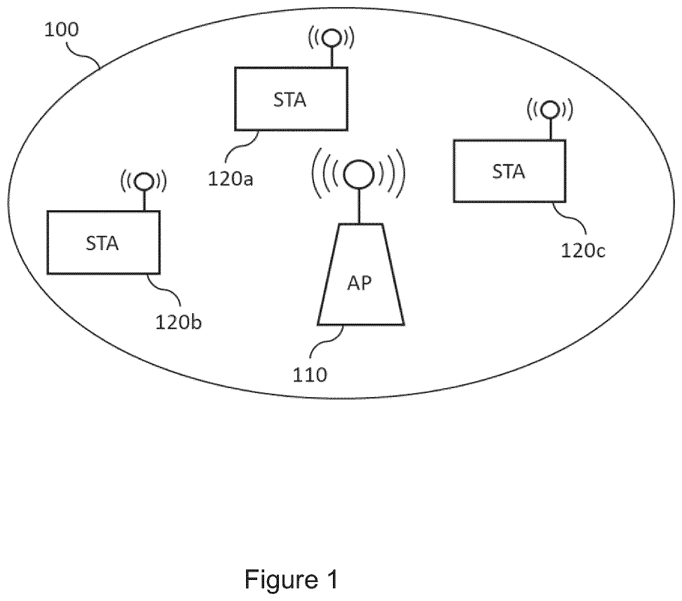

FIG. 1 illustrates an example of a network system in which embodiments of the invention may be used.

FIG. 1 represents an 802.11 network (i.e., a Wi-Fi® network) system 100 comprising four wireless devices: an access point (AP) station 110 and three non-AP stations (non-AP STAs) 120a, 120b, 120c. Of course, the number of non-AP stations 120a, 120b, 120c may be different from three. The AP station 110 provides wireless connections between the non-AP stations 120a, 120b, 120c and a wider network, such as the Internet. The connection of a non-AP station 120a, 120b, 120c to the AP station 110 is performed by a standardized process called association. Once a non-AP station 120a, 120b, 120c is associated with the AP station 110, the non-AP station 120a, 120b, 120c can send data to the network and receive data from the network through the AP station 110.

The AP station 110 may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance a broadband remote access server (BRAS).

A non-AP station 120a, 120b, 120c may comprise, be implemented as, or known as a subscriber station, a subscriber unit, a mobile station (MS), a remote station, a remote terminal, a user terminal (UT), a user agent, a user device, a user equipment (UE), a user station (STA), or some other terminology. In some implementations, a non-AP station 120a, 120b, 120c may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station 120a, 120b, 120c may be a wireless node. Such wireless node may provide, for example, connectivity for or to a network (e.g., a wide area network such as the Internet or a cellular network) via a wired or wireless communication link.

The AP station 110 manages a set of stations that together organize their accesses to the wireless medium for communication purposes. All the stations (AP station 110 and non-AP station 120a, 120b, 120c) form a service set, which may be referred to as basic service set, BSS (although another terminology can be used). It is noted that the AP station 110 can manage more than one BSS: each BSS is thus uniquely identified by a specific basic service set identifier (BSSID) and managed by a separate virtual AP station implemented in the physical AP station 110.

In order to ensure user privacy, the AP station 110 and the non-AP STAs 120a, 120b, 120c have been configured with a dot11MACPrivacyActivated set to true. This is a Management Information Base (MIB) variable controllable by an external management entity to define whether the non-AP station can apply (variable set to true) specific mechanisms for enhancing the privacy at MAC level.

A dedicated task group 802.11bi has been initiated in 2019 to specify Privacy Enhancements (PE) features to be added in the standard to ensure a given level of privacy. The addressed PE features are relative to the obfuscation of multiple identified PE parameters when the stations send frame. The obfuscation consists in performing a simultaneous change of transmitted PE parameters (which are transmitted in clear in the frames) to uncorrelated new values (with the previous ones) without any loss of connection.

Two sets of privacy features or mechanisms have been defined. The first one, referred to as set of Client Privacy Enhancements (CPE) features, prevents the identification and the tracking of a Client (non-AP STA). The second one, referred to as set of BSS Privacy Enhancements (BPE) features, prevents the identification and the tracking of a BSS. From these, an AP station implementing CPE features is referred to as CPE-capable AP or CPE AP and a non-AP station implementing CPE features is referred to as CPE-capable non-AP STA or CPE non-AP STA or CPE Client. Similarly, an AP station implementing BPE features is referred to as BPE-capable AP or BPE AP and a non-AP station implementing BPE features is referred to as BPE-capable non-AP STA or BPE non-AP STA or BPE Client.

The PE capability is exchanged during the association procedure of a Client with an AP. If both the Client is a CPE Client and the AP is a CPE AP, the CPE features are activated and the Management Information Base (MIB) dot11MACEnhancedPrivacyActivated is set to true. Otherwise, it is set to false.

The CPE features involving the obfuscation of multiple PE parameters relative to a CPE Client (referred to as CPE parameters) are here implemented through a procedure referred to as Client ERCM procedure. It may be initiated by the CPE Client, referring to as initiating CPE client. Similarly, the BPE features involving the obfuscation of multiple PE parameters relative to a BPE AP and potentially some or all BPE Clients associated with the BPE AP (referred to as BPE parameters) are here implemented through a procedure referred to as BSS ERCM procedure. It may be initiated by the BPE AP.

As apparent from the above, “PE” can be used as a generalization of “BPE” and “CPE” and the “ERCM procedure” can be used as a generalization of the “Client ERCM procedure” and “BSS ERCM procedure”

Depending on the scenario, the AP STA 110 is a CPE AP and the non-AP STA 120a, 120b, 120c are CPE Clients to implement a Client ERCM procedure, or the AP STA 110 is a BPE AP and the non-AP STA 120a, 120b, 120c are BPE Clients to implement a BSS ERCM procedure.

According to other embodiments, the AP STA 110 is both a CPE and BPE AP and the non-AP STA 120a, 120b, 120c are both CPE and BPE Clients. The Client and BSS ERCM procedures may thus be implemented in parallel.

Exemplary PE parameters include the following ones which only regard the CPE Clients (the CPE parameters being therefore PE Client parameters):
the MAC address of the CPE Client (i.e., non-AP station) for over-the-air (OTA) communications, and more generally any Extended Unique Identifier (EUI) of the non-AP station. The transmitted MAC address is referred to as OTA MAC Address, which is indicated either in the Transmitter Address (TA) field or the Receiver Address (RA) field of the IEEE 802.11 frames (corresponding to address 2 or 3). Optionally, the CPE Client may have several OTA MAC addresses, each one used for a given purpose: a MAC address when exchanging data, another MAC address when exchanging measurements, a MAC address when transmitting, a MAC address when receiving, and so on. In a context of Multi-Link Operations (MLO), the MAC address of a MLD to which the STA is affiliated (MLD MAC address) may be also considered and obfuscated in addition to the MAC addresses of its affiliated STAs.
the Sequence Numbers (SN) which are used by the CPE Client to uniquely identify a new MSDU (MAC Service Data Unit), A-MSDU (Aggregated-MSDU), or MMPDU (MAC Management Protocol Data Unit) to be transmitted. They are incremented for each frame transmission and remain constant in case of a frame retransmission. In some embodiments, two SNs are considered as PE parameters for the CPE Client: a first one used for uplink transmissions from the CPE Client to the AP station (Uplink SN) and a second one used for unicast/individual downlink transmissions from the AP station to the CPE Client (Downlink SN). The transmitted (or OTA) SNs are included in the Sequence Number field of the Sequence Control field of the MAC Header of an 802.11 frame. It is a 12-bit field.
the Packet Number (PN) which is used for the encryption of the frame and allows to uniquely identify the frame being transmitted for replay detection. The packet number is incremented at each new frame transmission and remains constant in case of a frame retransmission. It is therefore used by the CPE Client to uniquely identify a new frame to be transmitted. In some embodiments, two PNs are considered as PE parameters for the CPE Client: a first one used for uplink transmissions from the CPE Client to the AP station (Uplink PN) and a second one used for unicast/individual downlink transmissions from the AP station to the CPE Client (Downlink PN). The transmitted (or OTA) PNs are included in the Packet Number field of the CCMP Header of the plaintext MAC payload of the frame. It is a 48-bit packet number.
the Association Identifier (AID) which is a unique identifier assigned by the AP station to the CPE Client during its association. It is a 16-bit field and the transmitted (or OTA) AID is included in many frames for different usages as the power saving or the resources allocation in the MU OFDMA.
the Scrambler Seed which corresponds to the seed used by the PHY scrambler to initialize its initial state, i.e., to initialize the local scrambler scrambling transmit data and/or descrambling receive data. The scramble seed is defined in section 17.3.5.5 of IEEE® 802.11-2020. It corresponds to a 7-bits and the transmitted (or OTA) Scrambler Seed is indirectly transmitted by prefixing the payload with 7 zeros in a field referred to as SERVICE field allowing the receiver to retrieve/reconstruct the scrambler seed (and decode the data). In some embodiments, two Scrambler Seeds are considered as PE parameters for the CPE Client: the first one relative to the PHY scrambler used for uplink transmissions from the CPE Client to AP station (Uplink Scrambler Seed) and the second one relative to the PHY scrambler used for unicast/individual downlink transmissions from the AP station to the CPE Client (Downlink Scrambler Seed).
the Traffic Identifier (TID) which is used to classify MAC frame for clients supporting quality of service (QoS) within the MAC data service. It is represented as a 4-bits number (B0-B3) identifying a QoS traffic. In an 802.11 frame, the transmitted (or OTA) TID is included in the TID subfield of the QoS Control field of the frame.

BPE parameters for BPE Clients, also named BPE Client parameters, include the same as the CPE parameters with respect to the BPE Clients.

Exemplary BPE parameters for the BPE AP, also named BPE AP parameters, include the following ones:
the OTA MAC address of the BPE AP which is indicated either in the Transmitter Address (TA) field or Receiver Address (RA) field of the IEEE 802.11 frames (corresponding to address 2 or 3). Optionally, the BPE AP may have several OTA MAC addresses, each one used for a given purpose as mentioned above for the CPE Clients. In a context of Multi-Link Operations (MLO), the MAC address of the MLD to which the AP is affiliated (MLD MAC address) may be also considered and obfuscated in addition to the MAC addresses of its affiliated APs.
the Sequence Numbers (SN) which are used to uniquely identify a new MSDU (MAC Service Data Unit), A-MSDU (Aggregated-MSDU), or MMPDU (MAC Management Protocol Data Unit) to be transmitted. They are incremented for each frame transmission and remain constant in case of a frame retransmission. In some embodiments, three types of SNs are considered as PE parameters for the BPE AP: one specific to unicast/individual uplink transmissions from each individual non-AP station to the BPE AP (Individual uplink SN corresponding to each non-AP station respectively), a second one specific to unicast/individual downlink transmissions from the BPE AP to each individual non-AP station (Individual downlink SN corresponding to each non-AP station respectively) and a third one specific to multicast or broadcast downlink transmissions intended to a group of STAs (group SN). In an 802.11 frame, the transmitted (or OTA) SNs are included in the Sequence Number field of the Sequence Control field of the MAC Header of an 802.11 frame. It is a 12-bit field.
the Packet Number (PN) which is used for the encryption of the frame and allows to uniquely identify the frame being transmitted for replay detection. The packet number is incremented for each frame transmission and remains constant in case of a frame retransmission. It is therefore used by the BPE AP to uniquely identify a new frame to be transmitted. In some embodiments, three types of PNs are considered as PE parameters for the BPE AP: one specific to unicast/individual uplink transmissions from each individual non-AP station to the BPE AP (Individual uplink PN corresponding to each non-AP station respectively), a second one specific to unicast/individual downlink transmissions from the BPE AP to each individual non-AP station (Individual downlink PN corresponding to each non-AP station respectively) and a third one specific to multicast or broadcast downlink transmissions intended to s group of STAs (Group PN). In an 802.11 frame, the transmitted (or OTA) PNs are included in the Packet Number field of the CCMP Header of the plaintext MAC payload of the frame. It is a 48-bit packet number.
the Scrambler Seed which corresponds to the seed used by the PHY scrambler to initialize its initial state, i.e., to initialize the local scrambler scrambling transmit data and/or descrambling receive data. In some embodiments, three types of Scrambler Seeds are considered as PE parameters for the BPE AP: the first one relative to the PHY scramblers used for unicast/individual uplink transmissions from each individual non-AP station to the BPE AP (Individual uplink Scrambler Seed corresponding to each non-AP station respectively), a second one specific to unicast/individual downlink transmissions from the BPE AP to each individual non-AP station (Individual downlink Scrambler Seed corresponding to each non-AP station respectively) and a third one specific to multicast or broadcast downlink transmissions intended to a group of STAs (Group Scrambler Seed). They correspond to a 7-bits and the transmitted (or OTA) Scrambler Seeds are indirectly by prefixing the payload with 7 in a field referred to as SERVICE field allowing the receiver to retrieve/reconstruct the scrambler seed (and decode the data).
the Beacon Interval which corresponds to the difference or time interval between two Target Beacon Transmission Times (TBTTs), a TBTT being the time at which the AP station is configured to send its beacon frame. The beacon Interval is given in Time Units (TU), a TU being equal to 1024 microseconds. In an 802.11 frame, the transmitted (or OTA) Beacon Interval is included in the Beacon Interval field of each beacon frame. It is a 16-bit field set to the number of TU between Beacon transmissions.
the Timing Synchronization Function (TSF) timer used to synchronize the STAs of the BSS. In an 802.11 frame, the transmitted (or OTA) TSF timer is included in the Timestamp field of each beacon frame. It is a 8-byte field.
the Traffic Identifier (TID) which is used to classify MAC frame for clients supporting quality of service (QoS) within the MAC data service. It is represented as a 4-bits number (B0-B3) identifying a QoS traffic. In an 802.11 frame, the transmitted (or OTA) TID is included in the TID subfield of the QoS Control field of the frame.
the BSS Color which has been introduced by IEEE 802.11ax task group used to identify a BSS. It is a 6-bits parameter. In an 802.11 frame, the transmitted (or OTA) BSS Color is included in the BSS Color field of the BSS Color Information of HE Operation element within Beacon, Probe Response and (Re) Association frames.

These lists of CPE/BPE parameters are not exhaustive and other CPE/BPE parameters can be considered as PE parameters. Moreover, the Client ERCM procedure and BSS ERCM procedure may choose to obfuscate only a part of these PE parameters.

The obfuscation of a PE parameter corresponds to a change of the value of its corresponding transmitted PE parameter transmitted in clear in the 802.11 frame to a new value uncorrelated with the previous ones.

Two obfuscation operations are conducted on separate PE parameters.

The first one is referred to as a reset-based obfuscation operation. A new value is obtained for the PE parameter considered and is used to reset the PE parameter itself. This is the new (reset) value that is the transmitted (OTA) PE parameter included in the exchanged 802.11 frames.

The second one is referred to as a reset-free obfuscation operation or mask-based obfuscation operation. Rather than resetting the value of the PE parameter considered, the operation encodes the PE parameter in order to generate an encoded PE parameter which is used as the new value for the corresponding transmitted (OTA) PE parameter included in the exchanged 802.11 frames. The mask-based obfuscation operation may thus also be considered as an encoding-based obfuscation operation.

The encoding operation may take as inputs the local current value of the PE parameter considered and an encoding parameter shared by the encoder and the decoder. The encoding operation may be a mere masking, in which case the shared encoding parameter is a shared mask having the same binary length as the PE parameter considered. An exemplary encoding operation is the masking XOR operation.

Alternatives to masking may include adding or subtracting the shared encoding parameter as an offset to the current value of the PE parameter considered. A variant may include binary rotating the bits of this current value based on the shared encoding parameter. In these alternatives, the shared encoding parameter value may be a random value.

In order to protect privacy, the obfuscation, whatever the operation, requires that the successive values of each transmitted (OTA) PE parameter considered are uncorrelated. For the reset-based obfuscation operation, the reset value itself has to be uncorrelated with the previous (current) value of the PE parameter considered. For the mask-based obfuscation operation, the shared mask (or encoding parameter) may be generated in an uncorrelated fashion.

To do so, a pseudorandom function (PRF) is used to generate the new reset values and the new masks, each time the CPE or BPE parameters need to be changed with a new obfuscation. According to the invention, the same and single execution of the shared pseudorandom function, with a current value of at least one input shared with the other station, simultaneously generates the new reset value or values for one or more PE parameters (here below referred to as reset-based PE parameters) to obfuscate and the new mask or masks (or more generally encoding parameter values) for one or more PE parameters to obfuscate through encoding or masking (here below referred to as encoding or reset-free or mask-based PE parameters).

The PRF may be the one specified in the section 12.7.1.2 of the standard IEEE Std 802.11-2020. Alternatively, any block cipher algorithm allowing to cipher a block, with similar input parameters (shared key and shared parameter having a value varying over time) may be used as shared function. Below it is mainly made reference to the PRF for simplicity, although alternative shared functions, such as a hash function, can be used in the same way.

In the following, a PE Parameter operating the reset-based obfuscation operation is referred to as a “PE parameter to be reset” or “reset-based PE parameter” at the emission side and “reset PE parameter” or “reset-based PE parameter” at the reception side and a PE Parameter operating the (reset-free) encoding obfuscation operation is referred to as “PE parameter to be encoded” or “reset-free PE parameter” or “mask-based parameter” at the emission side and “encoded PE parameter” or “reset-free PE parameter” or “mask-based parameter” at the reception side.

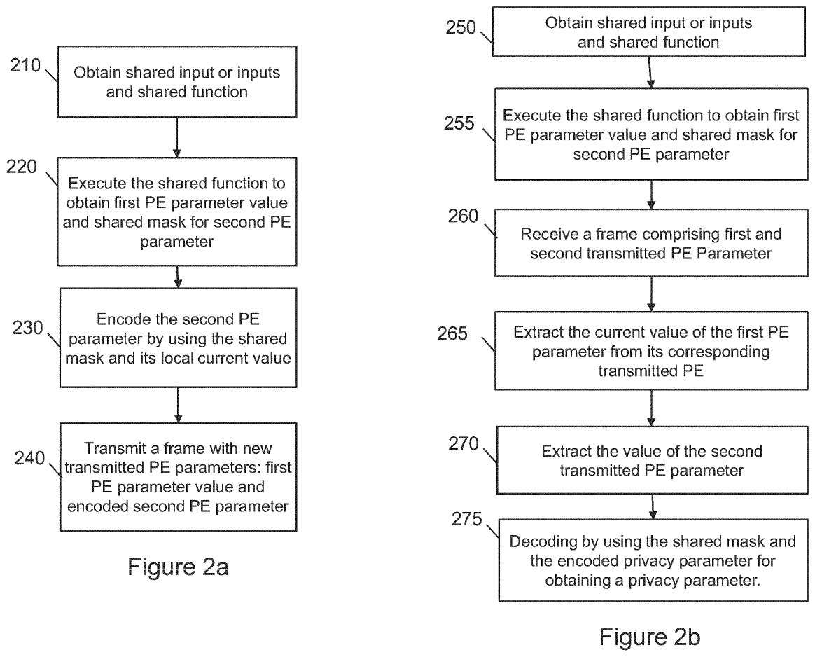

FIGS. 2a and 2b illustrate, using flowcharts, general steps of a method for obfuscating multiple PE parameters in a frame, mixing reset-based obfuscation operation and mask-based (encoding) obfuscation operation. For ease of explanation, a single reset-based PE parameter is mentioned (“first privacy parameter”) although a plurality of such parameters could be obfuscated using the reset-based obfuscation operation. Similarly, a single mask-based PE parameter is mentioned (“second privacy parameter”) although a plurality of such parameters could be obfuscated using the mask-based obfuscation operation.

Also for ease of explanation, it is made reference to the PRF as an exemplary shared function. Of course, other shared functions may be used.

In the same way, it is made reference to two inputs to the shared function, namely a shared key and a shared generation parameter, while other shared inputs may be added as well as a single shared input may be used. As an example, a single input may be a concatenation of the above key and generation parameter.

The frame carrying the obfuscated values as OTA (or transmitted) PE parameters is transmitted by a first PE STA and received by a second PE STA. The first PE STA may be the AP station or a non-AP station. Accordingly, the second PE STA is a non-AP station or the AP station respectively. At least one of the PE STA (first or second) is the AP station.

FIG. 2a illustrates the general steps performed by the first PE STA at transmission side while FIG. 2b illustrates the general steps performed by the second PE STA at reception side. These Figures apply for any or both of the BSS ERCM procedure (initiated by the AP station based on any triggering event) and the Client ERCM procedure (initiated by the non-AP station based on any triggering event).

At step 210, the first STA obtains the shared input or inputs, typically a key shared with the second STA referred to as ERCM key, as well as a generation parameter also shared with the second STA which parameter evolves over time. The shared function, such as the PRF, is also retrieved.

In one or more embodiments, the ERCM key may be a key obtained during the authentication and association procedures between the non-AP station and the AP station. For example, after a successful authentication, the non-AP station and the AP station have a shared key called Pairwise Master Key (PMK), which is common to all the non-AP stations of the BSS. After authentication, a 4-Way handshake is performed, during which a key specific to each non-AP station is derived from the PMK, called Pairwise Transient Key (PTK), which is the key to be used for ciphering communications between the non-AP station and the AP station. In one or several embodiments, the PTK or a derivative thereof is used as ERCM key.

In alternative embodiments, the ERCM key is generated by the AP station through generation of a sequence of random bits (typically 256 bits) which is encrypted by the KEK of the PTK (with GTK, IGTK and BIGTK) and is finally shared in the third message during the 4-way handshake.

In other alternative embodiments, the ERCM key may correspond to any key shared between the non-AP station and the AP station. For example, this shared key may be stored in the memory of the device comprising the AP station (e.g., an internet connection box), and may also be read by a user on the housing of this device. The user may then enter this shared key manually, for example by means of a touch screen, into the user equipment comprising the non-AP station. Of course, other solutions for the user equipment comprising the non-AP station to recover the ERCM key are possible. For example, the ERCM key may be read elsewhere than on the housing of the device comprising the AP station (e.g., on a notice supplied with the device), or can be received directly on the user equipment comprising the non-AP station from another equipment (e.g., by Short Message Service, SMS, or via a Bluetooth® connection). It is noted that in these embodiments, the ERCM key is common to all the non-AP stations.

In the above embodiments, the ERCM key is not exchanged or not exchanged in clear between the non-AP station and the AP station. Therefore, the ERCM key cannot be recovered by a third party which would listen to the communications between the two stations. This avoids this third party to be able to use the PRF with the same inputs as the two stations, hence avoids it to calculate the new reset values for the reset-based PE parameters and the new masks for the mask-based PE parameters as described below. The security of the PE Parameter obfuscation through the ERCM procedure is thus guaranteed.

The generation parameter is shared by all the STAs impacted by the ERCM procedure. It is a shared parameter for the calculation. According to an embodiment, this shared parameter is a current OTA MAC address of one of the two stations, in particular the station whose PE parameters are changed (i.e., the non-AP station for CPE parameter change and the AP station for BPE parameter change). Alternatively, the current value of any of the PE parameters to be changed can be used. Yet alternatively, the current value of any PE parameter can be used (any CPE parameter when changing some CPE parameters or any BPE parameter when changing some BPE parameters). According to another embodiment, it may contemplate using another shared generation parameter value, e.g., from predefined parameters such as the current time, and so on.

The shared function is a function locally implemented at the first and the second stations. It is typically a pseudorandom function which generates from a set of input parameters a sequence of pseudorandom bits of a given length. As explained below, it takes as inputs at least the shared key and the shared generation parameter value.

Once the shared elements are known and retrieved, step 220 executes the shared function once with the current value of the shared input or inputs (e.g., shared key and current value of the shared generation parameter). This generates a result value or generation output that is a binary sequence or sequence of bits. From this result value, the new reset value for the first privacy parameter can be obtained as well as the encoding parameter value for the second privacy parameter. The first privacy parameter value is made of a first chunk or bit subset of the result value and the encoding parameter value is made of a second chunk or bit subset of the result value. The two chunks are preferably disjoint within the result value.

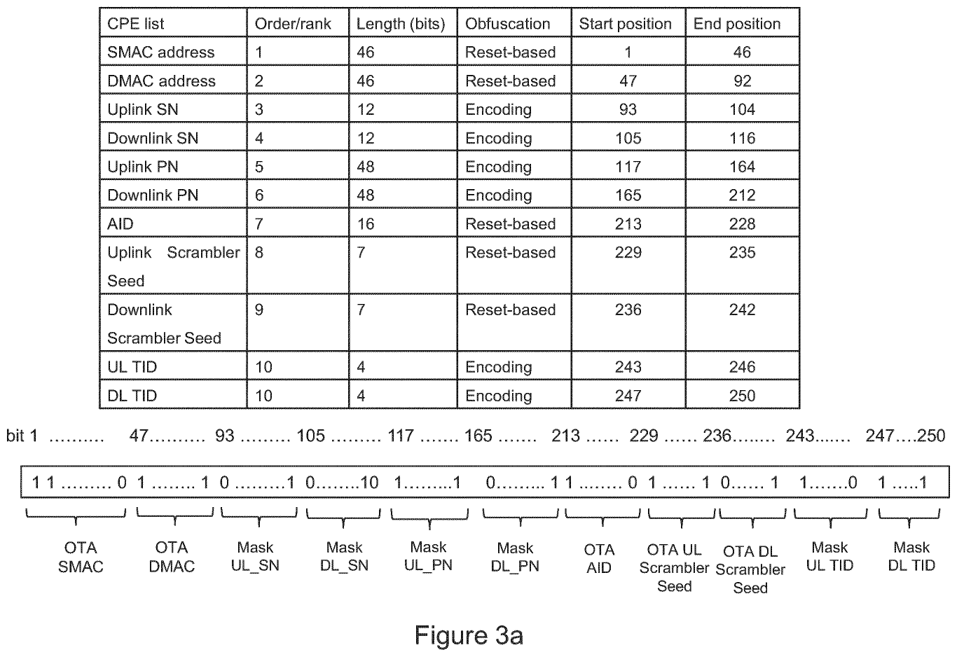

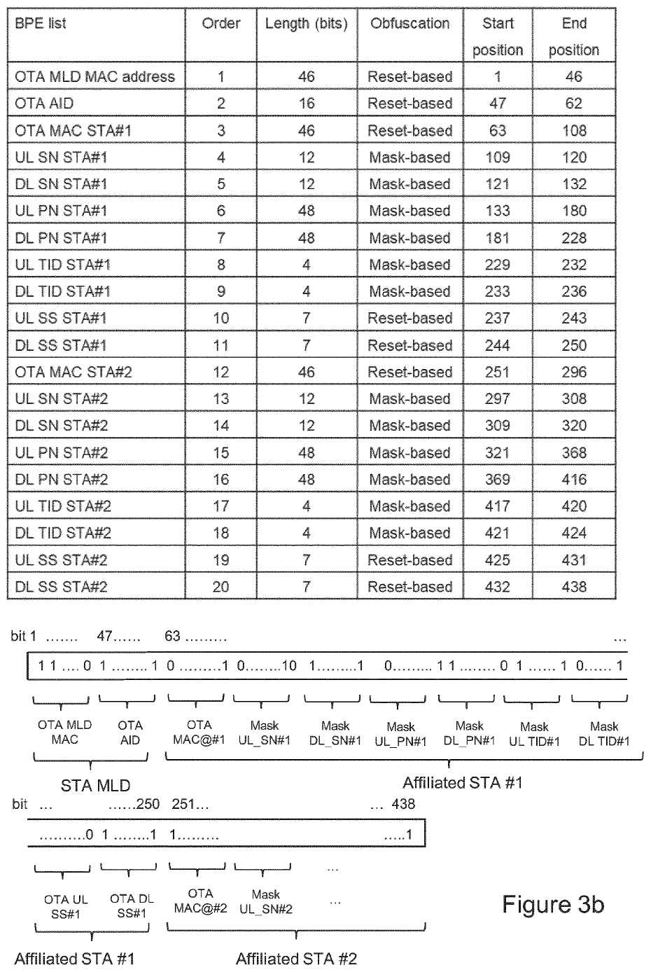

The matching between each PE (or privacy) parameter and a chunk or bit subset of the result value may be predefined. FIGS. 3 to 5 illustrate various examples of matching.

Of course, according to the binary length of the result value, multiple reset-based privacy parameter values and/or multiple encoding (reset-free) parameter values may be obtained as multiple (e.g., disjoint) chunks of the result value. Hence, a single execution of the shared function may allow obfuscating values or masks to be obtained for all the PE parameters (CPE or BPE) at once.

In embodiments, if the new value of an encoding parameter (e.g., a mask) corresponds to the null value (meaning e.g., no masking), a predetermined substitute mask is used.

At step 220, a new value for the first PE parameter operating a reset-based obfuscation operation is obtained, as well as a shared mask for the second PE parameter operating an encoding (mask-based) obfuscation operation.

Next, at step 230, the second PE parameter is obfuscated by using an encoding operation to encode the current value of this parameter based on the shared encoding parameter (mask). This may consist in XORing the current value of the second PE parameter and the new value of the shared mask as obtained at step 220.

Of course, if other masks are available for other mask-based PE parameters, their masking is also performed at this step 230.

At this stage, the first PE parameter is now obfuscated with the new value obtained through the first chunk while the second PE parameter is obfuscated by mere masking based on the mask obtained through the second chunk. The obfuscated values can then be used as transmitted (OTA) parameters.

In this respect, at step 240, the first station transmits a frame by setting the transmitted PE parameter of the first PE parameter to the first privacy parameter value determined at step 220 and the transmitted PE parameter of the second PE parameter to the encoded second privacy parameter value determined at step 230.

On reception side as shown in FIG. 2b, the second station performs steps 250 and 255 that correspond to steps 210 and 220: obtaining the shared elements and executing the PRF to obtain the first PE parameter value and the shared encoding parameter (mask).

Step 260 illustrates the reception of a frame (sent at step 240 by the first station) comprising first and second transmitted PE parameters. The first transmitted PE parameter corresponds to the first PE parameter value. The second transmitted PE parameter corresponds to the encoded second PE parameter value.

At step 265, the value of the first PE Parameter is retrieved by extracting its corresponding transmitted PE in the received frame. The second station may then directly check whether the value is correct, i.e., whether it matches the first privacy parameter value. As an example where the first PE parameter is the MAC address of the second station, the second station may further process the received frame only if the destination OTA MAC address specified in the frame matches its own new OTA MAC address (first privacy parameter value); otherwise it discards the frame.

Next, as step 270, the second station extracts the transmitted PE value of the second PE parameter from the received frame.

As the retrieved value is encoded, the second station needs to decode it. This is done at step 275 where the second station decodes the second PE parameter by using a decoding operation involving the shared encoding parameter (mask) obtained at step 255 and the transmitted PE value extracted at step 270. This may consist in XORing the shared encoding parameter and the transmitted PE value. The decoded result corresponds to the current value of the second PE parameter. The second station may then use this decoded value for the purpose of initiating and launching specific mechanism. As an example where the second PE parameter is the packet number, the second station may sort the received frames according to the decoded values of the second PE parameter.

The order between step 265 on one hand and steps 270-275 on the other hand can be inverted. Also, they may be performed in parallel.

In alternative embodiment, the frame transmitted at step 240 does not include the transmitted PE parameter of the first PE parameter (as it is computed by the receiving station at step 255).

FIGS. 3a, 3b, 4 and 5 illustrate exemplary PE parameters subject to the obfuscation operations according to embodiments of the invention. They show exemplary selections of the PE parameters listed above. Of course, any other selection may be contemplated.

FIG. 3a illustrates a first ordered list of eleven CPE parameters obfuscated through the Client ERCM procedure, according to one or several embodiments of the invention.

The ordered list (in the Table) includes first a 46-bit MAC address (SMAC) of the non-AP station considered that is used for outgoing transmissions (46 bits because the U/L bit and I/G bit are fixed), followed successively by a 46-bit MAC address (DMAC) of the non-AP station considered that is used for ingoing transmissions, the 12-bit Uplink Sequence Number, the 12-bit Downlink Sequence Number, the 48-bit Uplink Packet Number, the 48-bit Downlink Packet Number, the 16-bit AID of the non-AP station, the 7-bit Uplink Scrambler Seed, the 7-bit Downlink Scrambler Seed, a 4-bit Uplink TID used for uplink transmissions and then a 4-bit Downlink TID used for downlink transmissions. Of course, any other order may be contemplated. Also, a single 46-bit MAC address and/or a single 4-bit TID may be used for the non-AP station.

Each CPE parameter is associated with an obfuscation operation, either the reset-based obfuscation method or the encoding (mask-based) obfuscation method. The operation for each CPE parameter may be defined in advance, e.g., based on whether its continuity over frames or its original setting has an impact on mechanisms to launch.

In the Figure, the reset-based obfuscation method is defined for the following CPE parameters: MAC address, AID, Uplink Scrambler Seed and Downlink Scrambler Seed. Accordingly, the encoding obfuscation method is selected for the following CPE parameters: Uplink Sequence Number, Downlink Sequence Number, Uplink Packet Number, Downlink Packet Number and TID.

Although the (current) values of these CPE parameters are usually included in a transmitted frame, in some embodiments, the transmitted CPE parameter values corresponding to the Uplink Sequence Number, the Downlink Sequence Number and the AID are omitted in the transmitted frame.

The last two columns of the table in the Figure define a CPE correspondence table indicating the matching between each chunk or binary subset of the result value (CPE output) from the execution of the shared function, with one of the listed CPE parameters. In the example, the shared function generates a result value having more than 203 bits. As an example, PRF-256 generating a 256-pseudorandom-bit output is appropriate.

The chunk or subpart starting from the first bit up to the 46th bit of the CPE output is allocated to the MAC address SMAC. The chunk starting from the 47th bit up to the 92th bit of the CPE output is allocated to the MAC address DMAC. The chunk starting from the 93th bit up to the 104th bit of the CPE output is allocated to the Uplink Sequence Number. The chunk starting from the 105th bit up to the 116th bit of the CPE output is allocated to the Downlink Sequence Number. The chunk starting from the 117th bit up to the 164th bit of the CPE output is allocated to the Uplink Packet Number. The chunk starting from the 165th bit up to the 212th bit of the CPE output is allocated to the Downlink Packet Number. The chunk starting from the 213th bit up to the 228th bit of the CPE output is allocated to the AID. The chunk starting from the 229th bit up to the 235th bit of the CPE output is allocated to the Uplink Scrambler Seed. The chunk starting from the 236th bit up to the 242th bit of the CPE output is allocated to the Downlink Scrambler Seed. The chunk starting from the 243th bit up to the 246th bit of the CPE output is allocated to the Uplink TID. The chunk starting from the 247th bit up to the 250th bit of the CPE output is allocated to the Downlink TID.

Depending on the obfuscation method (fourth column) for the CPE parameter, the value made by the chunk allocated to the CPE parameter has different meanings. If the reset-based obfuscation method is specified (in the fourth column) for the CPE parameter, the value of the chunk corresponds to the new (obfuscated) value of the CPE parameter. On the other hand, if the encoding obfuscation method is specified for the CPE parameter, the value of the chunk corresponds to the new value of the shared encoding parameter (e.g., the shared mask) to encode (e.g., mask) the CPE parameter into a transmitted (encoded) CPE parameter.

The bottom of the FIG. 3a illustrates the CPE output as a binary sequence, divided into eleven chunks corresponding to the eleven CPE parameters (following the order in the Table). An “OTA” label is provided for the reset-based CPE parameters because the corresponding chunk directly provides the new obfuscated CPE parameter value. On the other hand, a “Mask” label is provided for the mask-based CPE parameters because the corresponding chunk only provides the mask to be used to obfuscate the corresponding CPE parameter.

FIG. 3b illustrates a second ordered list of CPE parameters obfuscated through the Client ERCM procedure, according to one or several embodiments of the invention and more specially when the PE STAs are MLD. For illustration purpose, the MLD PE Client has two affiliated non-AP STAs referred to as STA #1 and STA #2.The second ordered list of CPE parameters includes CPE parameters of the MLD CPE Client (more precisely relative to the MLD upper MAC sublayer) and those of its affiliated non-AP STAs STA #1 and STA #2 (relative to MLD lower MAC layer).

The ordered list (in the Table) includes firstly CPE parameters related to the MLD CPE Client (more precisely relative to the MLD upper MAC sublayer) corresponding to the 46-bit MAC address used as MLD MAC address of the MLD CPE Client and the 16-bit AID of the MLD CPE Client.

Next, the ordered list includes CPE parameters related to the affiliated non-AP STA STA #1 of the MLD CPE Client (relative to MLD lower MAC layer) as its 46-bit MAC address used as the MAC address of the non-AP STAs STA #1, its 12-bit Uplink Sequence Number, its 12-bit Downlink Sequence Number, its 48-bit Uplink Packet Number, its 48-bit Downlink Packet Number, its 4-bit Uplink TID used for uplink transmissions, its 4-bit Downlink TID used for downlink transmissions, its 7-bit Uplink Scrambler Seed and its 7-bit Downlink Scrambler Seed. Of course, any other order may be contemplated.

Next, the ordered list includes CPE parameters related to the affiliated non-AP STAs STA #2 of the MLD CPE Client (relative to MLD lower MAC layer) as its 46-bit MAC address used as its MAC address, its 12-bit Uplink Sequence Number, its 12-bit Downlink Sequence Number, its 48-bit Uplink Packet Number, its 48-bit Downlink Packet Number, its 4-bit Uplink TID used for uplink transmissions, its 4-bit Downlink TID used for downlink transmissions, its 7-bit Uplink Scrambler Seed and its 7-bit Downlink Scrambler Seed. Of course, any other order may be contemplated.

Each CPE parameter is associated with an obfuscation operation, either the reset-based obfuscation method or the encoding (mask-based) obfuscation method. The operation for each CPE parameter may be defined in advance, e.g., based on whether its continuity over frames or its original setting has an impact on mechanisms to launch.

In the Figure, the reset-based obfuscation method is defined for the following CPE parameters: MAC address, AID, Uplink Scrambler Seed and Downlink Scrambler Seed. Accordingly, the encoding obfuscation method is selected for the following CPE parameters: Uplink Sequence Number, Downlink Sequence Number, Uplink Packet Number, Downlink Packet Number and TID.

Although the (current) values of these CPE parameters are usually included in a transmitted frame, in some embodiments, the transmitted CPE parameter values corresponding to the Uplink Sequence Number, the Downlink Sequence Number and the AID are omitted in the transmitted frame.

The last two columns of the table in the Figure define a CPE correspondence table indicating the matching between each chunk or binary subset of the result value (CPE output) from the execution of the shared function, with one of the listed CPE parameters. In the example, the shared function generates a result value having more than 438 bits. As an example, PRF-512 generating a 512-pseudorandom-bit output is appropriate.

The chunk or subpart starting from the first bit up to the 46th bit of the CPE output is allocated to the MLD MAC address of the MLD CPE Client. The chunk starting from the 47th bit up to the 62th bit of the CPE output is allocated to the AID of the MLD CPE Client.

Next, the sequence of chunks starting from the 63th bit up to the 250th bit corresponds to CPE parameters relative to non-AP STAs STA #1 of the MLD CPE Client. More precisely, the chunk starting from the 63th bit up to the 108th bit of the CPE output is allocated to its MAC address. The chunk starting from the 109th bit up to the 120th bit of the CPE output is allocated to its Uplink Sequence Number. The chunk starting from the 121th bit up to the 132th bit of the CPE output is allocated to its Downlink Sequence Number. The chunk starting from the 133th bit up to the 180th bit of the CPE output is allocated to its Uplink Packet Number. The chunk starting from the 181th bit up to the 228th bit of the CPE output is allocated to its Downlink Packet Number. The chunk starting from the 229th bit up to the 232th bit of the CPE output is allocated to its Uplink TID. The chunk starting from the 233th bit up to the 236th bit of the CPE output is allocated to its Downlink TID. The chunk starting from the 237th bit up to the 243th bit of the CPE output is allocated to the Uplink Scrambler Seed. The chunk starting from the 244th bit up to the 250th bit of the CPE output is allocated to its Downlink Scrambler Seed.

Next, the sequence of chunks starting from the 251th bit up to the 438th bit corresponds to CPE parameters relative to non-AP STAs STA #1 of the MLD CPE Client. More precisely, the chunk starting from the 251th bit up to the 296th bit of the CPE output is allocated to its MAC address. The chunk starting from the 297th bit up to the 308th bit of the CPE output is allocated to its Uplink Sequence Number. The chunk starting from the 309th bit up to the 320th bit of the CPE output is allocated to its Downlink Sequence Number. The chunk starting from the 321th bit up to the 368th bit of the CPE output is allocated to its Uplink Packet Number. The chunk starting from the 369th bit up to the 416th bit of the CPE output is allocated to its Downlink Packet Number. The chunk starting from the 417th bit up to the 420th bit of the CPE output is allocated to its Uplink TID. The chunk starting from the 421th bit up to the 424th bit of the CPE output is allocated to its Downlink TID. The chunk starting from the 425th bit up to the 431th bit of the CPE output is allocated to the Uplink Scrambler Seed. The chunk starting from the 432th bit up to the 438th bit of the CPE output is allocated to its Downlink Scrambler Seed.

Depending on the obfuscation method (fourth column) for the CPE parameter, the value made by the chunk allocated to the CPE parameter has different meanings. If the reset-based obfuscation method is specified (in the fourth column) for the CPE parameter, the value of the chunk corresponds to the new (obfuscated) value of the CPE parameter. On the other hand, if the encoding obfuscation method is specified for the CPE parameter, the value of the chunk corresponds to the new value of the shared encoding parameter (e.g., the shared mask) to encode (e.g., mask) the CPE parameter into a transmitted (encoded) CPE parameter.

The bottom of the FIG. 3b illustrates the CPE output as a binary sequence, divided into eleven chunks corresponding to the 20 CPE parameters (following the order in the Table). An “OTA” label is provided for the reset-based CPE parameters because the corresponding chunk directly provides the new obfuscated CPE parameter value. On the other hand, a “Mask” label is provided for the mask-based CPE parameters because the corresponding chunk only provides the mask to be used to obfuscate the corresponding CPE parameter.

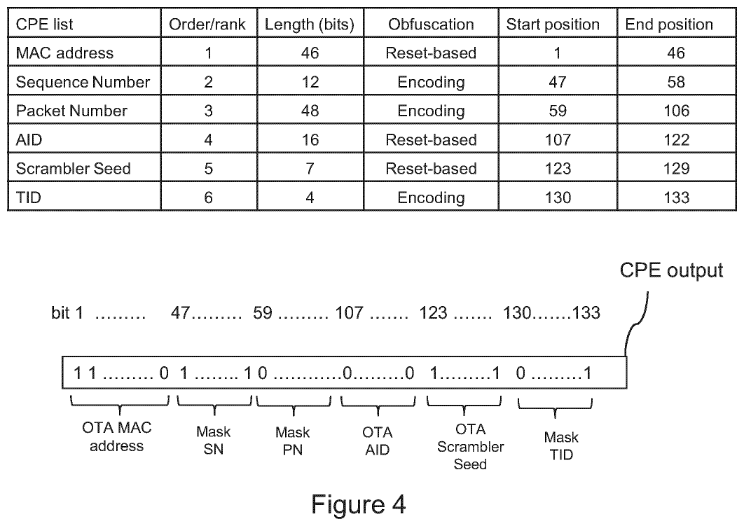

FIG. 4 illustrates a third ordered list that is shortened compared to FIG. 3a. The list comprises six CPE parameters obfuscated through the Client ERCM procedure, according to one or several embodiments of the invention.

The ordered list includes first the 46-bit MAC address of the non-AP station (46 bits because the U/L bit and I/G bit are fixed) followed by the 12-bit Sequence Number, the 48-bit Packet Number, the 16-bit AID, the 7-bit Scrambler Seed and then the 6-bit TID. Any other order may be contemplated. As in FIG. 3a, each CPE parameter is associated with an obfuscation operation, as follows: the reset-based obfuscation method is defined for the MAC address, the AID and the Scrambler Seed, while the encoding (mask-based) obfuscation method is specified for the Sequence Number, the Packet Number and the TID.

Although the (current) values of these CPE parameters are usually included in a transmitted frame, in some embodiments, the transmitted CPE parameters corresponding to the Sequence Number and the AID are omitted in the transmitted frame.

The CPE correspondence table formed by the two last columns indicates the matching between each chunk or binary subset of the result value (CPE output) with one of the listed CPE parameters as follows: the chunk starting from the first bit up to the 46th bit of the CPE output is allocated to the MAC address; the chunk starting from the 47th bit up to the 58th bit of the CPE output is allocated to the Sequence Number; the chunk starting from the 59th bit up to the 106th bit of the CPE output is allocated to the Packet Number; the chunk starting from the 107th bit up to the 122th bit of the CPE output is allocated to the AID; the chunk starting from the 123th bit up to the 129th bit of the CPE output is allocated to the Scrambler Seed; and the chunk starting from the 130th bit up to the 133th bit of the CPE output is allocated to the TID. As only 133 bits are required for the six CPE parameters, PRF-192 generating a 192-pseudorandom-bit output may be used.

The bottom of the FIG. 4 illustrates the CPE output as a binary sequence, divided into six chunks corresponding to the six CPE parameters (following the order in the Table). An “OTA” label is provided for the reset-based CPE parameters because the corresponding chunk directly provides the new obfuscated CPE parameter value. On the other hand, a “Mask” label is provided for the mask-based CPE parameters because the corresponding chunk only provides the mask to be used to obfuscate the corresponding CPE parameter.

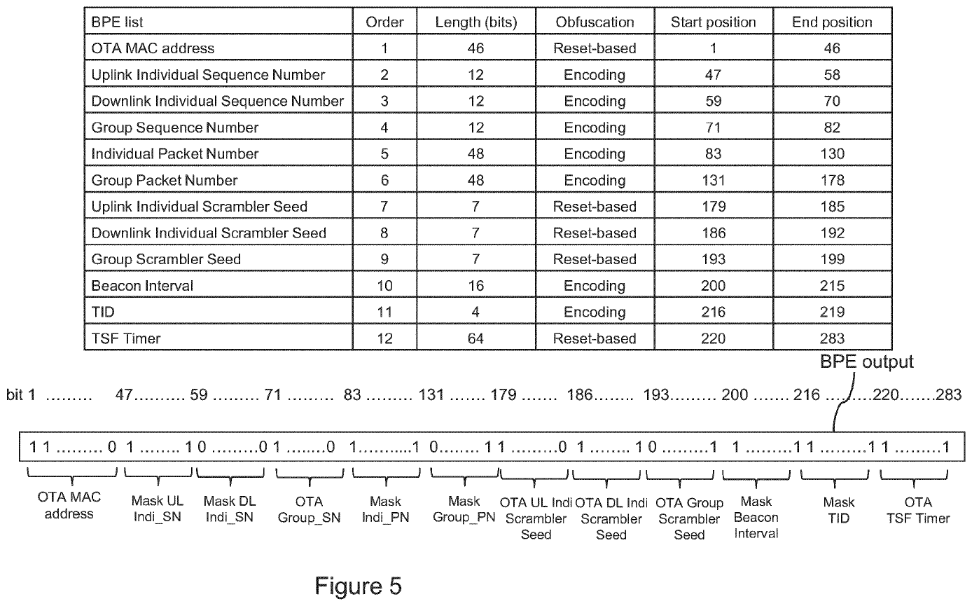

FIG. 5 illustrates an ordered list of twelve BPE parameters obfuscated through the BSS ERCM procedure, according to one or several embodiments of the invention.

The ordered list (in the Table) includes first the 46-bit MAC address of the AP station (46 bits because the U/L bit and I/G bit are fixed) followed by the 12-bit Uplink Individual Sequence Number, the 12-bit Downlink Individual Sequence Number, the 12-bit Group Sequence Number, the 48-bit (Uplink and Downlink) Individual Packet Numbers, the 48-bit Group Packet Number, the 7-bit Uplink Individual Scrambler Seed, the 7-bit Downlink Individual Scrambler Seed, the 7-bit Group Scrambler Seed, the 8-bit Beacon Interval, the 4-bit TID and then the 64-bit TSF Timer. Any other order may be contemplated. Similarly, any other set of BPE privacy parameters may be contemplated.

As for the table shown in FIG. 3a, two MAC addresses SMAC and DMAC and/or two TIDs, namely STID and DTID, may be used instead of a single MAC address and/or a single TID.

As in FIGS. 3a and 4, each BPE parameter is associated with an obfuscation method, as follows: the reset-based obfuscation method is set for the MAC address, the Individual Scrambler Seeds and the Group Scrambler Seed, while the encoding (mask-based) obfuscation method is specified for the Individual Sequence Numbers, the Group Sequence Number, Individual Packet Numbers, the Group Packet Number, the Beacon Interval and the TID.

Although the (current) values of these BPE parameters are usually included in a transmitted frame, in some embodiments, the transmitted BPE parameters corresponding to the Individual Sequence Number and the Group Sequence Number are omitted in the transmitted frame.

The BPE correspondence table formed by the two last columns indicates the matching between each chunk or binary subset of the result value (BPE output) with one of the listed BPE parameters as follows: the chunk starting from the first bit up to the 46th bit of the BPE output is allocated to the MAC address; the chunk starting from the 47th bit up to the 58th bit of the BPE output is allocated to the Uplink Individual Sequence Number; the chunk starting from the 59th bit up to the 70th bit of the BPE output is allocated to the Downlink Individual Sequence Number, the chunk starting from the 71th bit up to the 82th bit of the BPE output is allocated to the Group Sequence Number; the chunk starting from the 83th bit up to the 130th bit of the BPE output is allocated to the Individual Packet Number; the chunk starting from the 131th bit up to the 178th bit of the BPE output is allocated to the Group Packet Number; the chunk starting from the 179th bit up to the 185th bit of the BPE output is allocated to the Uplink Individual Scrambler Seed; the chunk starting from the 186th bit up to the 192th bit of the BPE output is allocated to the Downlink Individual Scrambler Seed; the chunk starting from the 193th bit up to the 199th bit of the BPE output is allocated to the Group Scrambler Seed; the chunk starting from the 200th bit up to the 215th bit of the BPE output is allocated to the Beacon Interval; the chunk starting from the 216th bit up to the 219th bit of the BPE output is allocated to the TID; and the chunk starting from the 220th bit up to the 283th bit of the BPE output is allocated to the TSF Timer. As 263 bits are required for the twelve BPE parameters, PRF-384 generating a 384-pseudorandom-bit output may be used.

The bottom of the FIG. 5 illustrates the BPE output as a binary sequence, divided into twelve chunks corresponding to the twelve BPE parameters (following the order in the Table). An “OTA” label is provided for the reset-based BPE parameters because the corresponding chunk directly provides the new obfuscated BPE parameter value. On the other hand, a “Mask” label is provided for the mask-based BPE parameters because the corresponding chunk only provides the mask to be used to obfuscate the corresponding BPE parameter.

In this example, a single Mask for Individual Packet Number is generated that may be used to mask both Individual Uplink Packet Number and Individual Downlink Packet Number. Of course, two separate masks may be generated through the BPE output. In other embodiments, a single Mask could be generated for the three types of PNs (Individual uplink, Individual downlink and Group).

In the same vein, multiple masks (chunks in the binary CPE or BPE output) may be obtained that are associated with the same PE parameter to obfuscate. In the MLD context, each of these masks may be assigned to a respective one of the multiple links of the MLD, and then the PE parameter to be included in a frame that is to be sent over a given link is obfuscated using the mask assigned to the given link. This even more increase privacy for a PE parameter that is used over the multiple links.

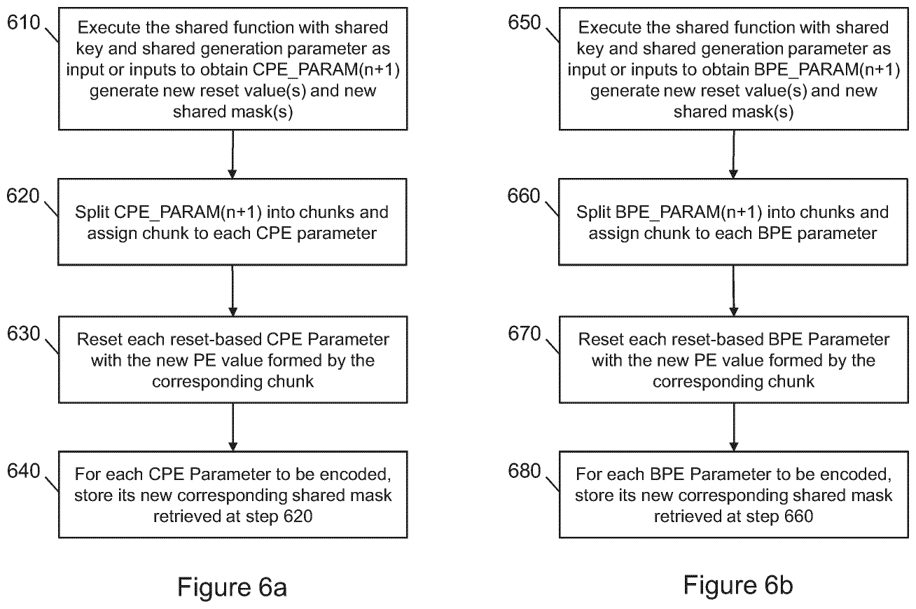

FIG. 6a illustrates, using a flowchart, exemplary steps performed by CPE stations for which a Client ERCM procedure operates on a list of CPE Parameters, referred to as CPE list. Exemplary lists are shown in FIGS. 3 and 4. As mentioned above, any ordered list of two or more CPE Parameters can be contemplated.

Such a CPE list may be either predetermined or exchanged during the association procedure.

In a MLD context, according to some embodiments, the CPE list may be ordered by taking into account if the CPE parameter is relative to the MLD upper MAC sublayer or the MLD lower MAC layer. Additionally, the sub list corresponding to the CPE parameters relative to the MLD lower MAC layer may also be ordered according to the affiliated non-AP STAs

According to some embodiments, the Client ERCM procedure is initiated at each start of a time period referred to as epoch in which the new uncorrelated values computed by the shared function are applied during all along it. The epoch management is out of scope of the invention.

When a CPE Client initiates a Client ERCM procedure, referred to as operating STA or operating Client, the CPE client and the CPE AP perform in parallel steps 610, 620, 630 and 640. This is to always have the same current values for the CPE parameters.

Step 610 consists in executing the shared function with the shared key and the shared generation parameter as inputs, to generate a new reset value for each reset-based CPE parameter that (the new value) is uncorrelated with the previous value used and to generate a new shared mask (or more generally a shared encoding parameter) for each mask-based CPE parameter.

The shared function is a function locally implemented in the CPE STA and the CPE AP. It is a pseudorandom function which generates a sequence of pseudorandom bits of a given length from a set of input parameters. In one or several embodiments, it is the pseudorandom function (PRF) specified in the section 12.7.1.2 of the standard IEEE Std 802.11-2020. Alternatively, any block cipher algorithm allowing to cipher a block, with similar input parameters (shared key and shared parameter having a value varying over time) may be used. The description below mostly concentrates on the PRF for ease of explanation. However, similar considerations can be made with respect to any block cipher algorithm.

The PRF is based on three main input parameters, denoted K, A, B, as well as an auxiliary parameter Len specifying the number of pseudorandom bits (128, 192, 256, . . . ) generated by the PRF. Section 12.7.1.2 of the standard IEEE Std 802.11-2020 specifies six PRF functions: PRF-128, PRF-192, PRF-256, PRF-384, PRF-512 or PRF-704, generating respectively 128, 192, 256, 384, 512, or 704 randomized bits. The choice of the PRF functions depends on the desired length of the output binary sequence.

The main input parameter K is a secret key specific to the operating STA. The shared key corresponds to any key, referred to as ERCM key, shared between the operating CPE Client and the CPE AP. As mentioned above (description of step 210), the ERCM key may be the Pairwise Transient Key (PTK) for the operating CPE Client or a derivative thereof. For instance, the key derivation function PBKDF2 as specified in IETF RFC 2898 may be used as it is already embedded in the stations. Also, the ERCM key may be stored in the memory of the device comprising the CPE AP or printed on the housing of the device.

In yet other embodiments, the ERCM key may be generated at the CPE AP and transmitted to the operating CPE Client via a protected action frame for instance. Since the ERCM key is exchanged between the operating CPE Client and the CPE AP, the communications between these entities are secured.

Parameter A is a text string specific to the application for which the ERCM PRF is used. In the scope of the Client ERCM procedure, it may be set to string “Client ERCM”. Obviously, any other text strings may be used.

Parameter B is a variable length string which is known by all the STAs impacted by the Client ERCM procedure of the operating STA. It is a shared parameter for the generation of the CPE output by the shared function (hence it is a shared generation parameter). As mentioned above, the shared parameter may be a temporal reference Tn or the current MAC address of the operating STA or the current value of a CPE parameter to be changed. Alternatively, it may correspond to any CPE parameter of the operating STA, or may be any predefined value such as the current time, and so on.

When the CPE client and the CPE AP execute the PRF with the input parameters set as described above, a result value or “CPE output”, denoted CPE_PARAM(n+1), is generated corresponding to a sequence of pseudo random bits from which only the L leftmost bits are extracted. L defines the number of bits required and corresponds to the sum of the lengths of the CPE parameters of the CPE list.

At step 620, the output binary sequence CPE_PARAM(n+1) is split into predetermined “chunks” or subsets of bits as defined in the CPE correspondence table (last two columns in FIGS. 3 and 4 for example). Each chunk or subset is assigned to one of the CPE parameters as defined in the CPE correspondence table. As apparent from this table, each chunk is defined by the positions of its first bit (start position) and last bit (end position) within the CPE output. Its length L_CPE corresponds to the length of its assigned CPE parameter. Preferably, the chunks or subsets are separate or disjoint, meaning they do not overlap within the CPE output. Preferably, they are adjacent to reduce the needed length of the CPE output.

As a consequence, the generated CPE output has a length at least equal to the sum of the lengths of each CPE parameter within the CPE list.

FIG. 3a described above illustrates a CPE output obtained using the shared function PRF-256 (whose inputs are the shared ERCM key, string “Client ERCM” as parameter A, and a temporal reference Tn), from which the 250 leftmost bits are extracted:

$$CPE\_PARAM ( n + 1 ) = PRF - M / L ( ERCM Key , “ Client ERCM ” , Tn )$$

$$with M = 256 and L = 250.$$

Similarly, FIG. 3b described above illustrates a CPE output obtained using the shared function PRF-512 (whose inputs are the shared ERCM key, string “Client ERCM” as parameter A, and a temporal reference Tn), from which the 438 leftmost bits are extracted:

$$CPE\_PARAM ( n + 1 ) = PRF - M / L ( ERCM Key , “ Client ERCM ” , Tn )$$

$$with M = 512 and L = 438.$$

Similarly, FIG. 4 described above illustrates a CPE output obtained using the shared function PRF-192 (whose inputs are the shared ERCM key, string “Client ERCM” as parameter A, and a temporal reference Tn), from which the 133 leftmost bits are extracted:

$$CPE\_PARAM ( n + 1 ) = PRF - M / L ( ERCM Key , “ Client ERCM ” , Tn )$$

$$with M = 192 and L = 133$$

Once the chunks are retrieved and assigned to each corresponding CPE parameter, step 630 consists in resetting each reset-based CPE Parameter of the CPE list with the value formed by the corresponding chunk extracted at step 620.

Also at step 640, for each mask-based CPE Parameter, the new value of the associated shared mask formed by the corresponding chunk as extracted at step 620 is stored.

Steps 630 and 640 may be inverted or performed in parallel.

Similarly, to FIG. 6a, FIG. 6b illustrates, using a flowchart, exemplary steps performed by BPE stations for which a BSS ERCM procedure operates on a list of BPE Parameters, referred to as BPE list. An exemplary list is shown in FIG. 5. As mentioned above, any ordered list of two or more BPE Parameters can be contemplated.

Such a BPE list may be either predetermined or exchanged during the association procedure.

When a BPE AP initiates a BSS ERCM procedure, the BPE AP and the BPE Clients perform in parallel steps 650, 660, 670 and 680. A change in the PE parameters of the AP (BPE Parameters) impacts multiple non-AP stations, e.g., all the non-AP stations of the BSS. That is why multiple BPE Clients perform the process of the Figure. In such a way, all the stations have the same current values for the BPE parameters.

Step 650 consists in executing the shared function as described above for step 610, but with respect to the BPE parameters. The shared function is executed with the shared key and the shared generation parameter as inputs, to generate a new reset value for each reset-based BPE parameter that is uncorrelated with the previous value used and to generate a new shared mask (or more generally a shared encoding parameter) for each mask-based BPE parameter.

The PRF can still be used. Parameter A may be set to string “BSS ERCM” or any other text string. Shared parameter B may be set to a temporal reference or the current MAC address of the BPE AP, or alternatively to the current value of a BPE parameter to be changed, or to any BPE parameter, or even to any other shared value, e.g., predefined values such as the current time, and so on.

The ERCM key K used for step 650 is a key shared by all BPE Clients associated with the BPE AP. Such a key identifies the BPE AP and is shared, in a secret fashion (hence it is a secret key), with the BPE Clients, to be known by all. It may be a secret cryptographic key shared between the BPE AP and the BPE Clients. In one or more embodiments, the ERCM key K for step 650 is the Groupwise Temporal Key (GTK) provided by the AP station in the EAP-Key Message 3 during the 4-Way handshake mechanism with the non-AP stations wishing to associate. This GTK is conventionally used to generate the encryption keys which are used to cipher data sent by the AP station over the wireless medium. In another embodiment, the ERCM key for step 650 may be inherited or derived from GTK by using any block ciphers which encrypt a block of data of fixed size. For instance, the key derivation function PBKDF2 as specified in IETF RFC 2898 may be used as it is already used embedded in the stations.

In other embodiments, the ERCM key for step 650 may be generated by the BPE AP and transmitted to the BPE Clients via for instance a protected action frame or an encrypted information element in the beacon frame. Since the ERCM key is exchanged between the BPE AP and all its associated BPE Clients, the communications between these entities is preferably secured.

When the BPE AP and the BPE clients execute the PRF with the input parameters set as described above, a result value or “BPE output”, denoted BPE_PARAM(n+1), is generated corresponding to a sequence of pseudo random bits from which only the L leftmost bits are extracted. L defines the number of bits required and corresponds to the sum of the lengths of the BPE parameters of the BPE list.

Step 660 then proceeds as step 620 with respect to the BPE parameters. In particular, BPE_PARAM(n+1) is split into predetermined “chunks” or subsets of bits according to the BPE correspondence table, and each chunk or subset is assigned to one of the BPE parameters as defined in the table. The table specifies the first bit (start position) and last bit (end position) of each BPE parameter within the BPE output.

FIG. 5 described above illustrates a BPE output obtained using the shared function PRF-384 (whose inputs are the shared ERCM key, string “BSS ERCM” as parameter A, and a temporal reference as parameter B), from which the 283 leftmost bits are extracted.

$$BPE\_PARAM ( n + 1 ) = PRF - M / L ( ERCM Key , “ BSS ERCM ” , Tn )$$

$$with M = 384 and L = 283$$

Once the chunks are retrieved and assigned to each corresponding BPE parameter, step 670 consists in resetting each reset-based BPE Parameter of the BPE list with the value formed by the corresponding chunk extracted at step 660.

Also at step 680, for each mask-based BPE Parameter, the new value of the associated shared mask formed by the corresponding chunk as extracted at step 660 is stored.

Steps 670 and 680 may be inverted or performed in parallel.

The methods of FIGS. 6a and 6b have produced new values for the reset-based CPE or BPE parameters, uncorrelated with the previous ones, and have stored the new shared masks for the mask-based CPE or BPE parameters. These new values can then be used to efficiently obfuscate the CPE or BPE parameters in the frames exchanges between the stations, without any loss of connection.

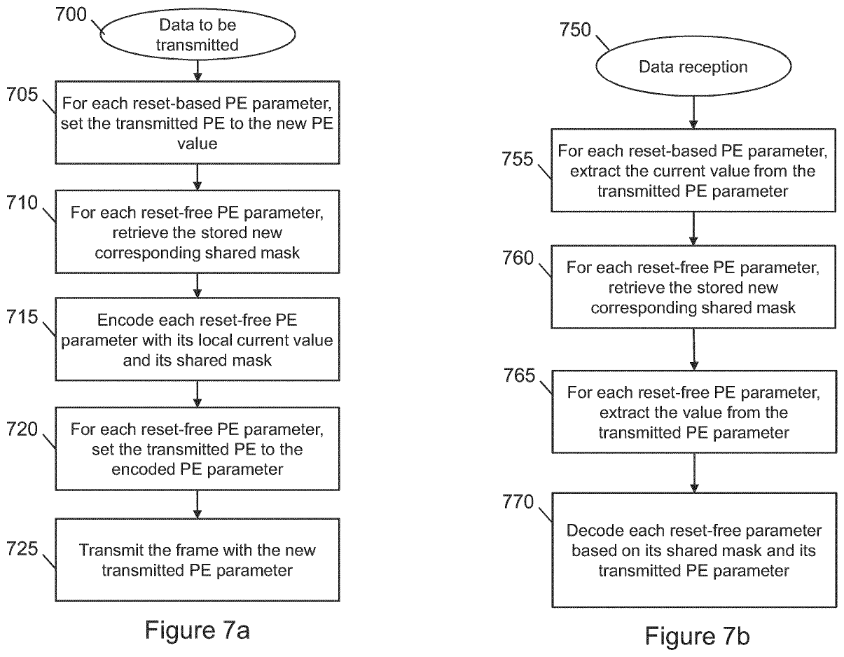

FIGS. 7a and 7b illustrate, using flowcharts, a communication method frame between two PE stations operating with an ERCM procedure, according to one or several embodiments of the invention.

They illustrate exemplary steps of transmission (FIG. 7a) and reception (FIG. 7b) of a frame from a first PE STA, referred to as transmitting PE STA, to a second PE STA, referred to as receiving PE STA. The stations have already performed the Client or BSS ERCM procedure of FIG. 6a or 6b.

At the transmission side, when the transmitting PE STA has a frame to transmit (step 700), the transmitting PE STA retrieves the list of PE parameters (called PE list) involved in the ERCM procedure.

Next, at step 705, the transmitting PE STA sets the transmitted PE parameter of each reset-based PE parameter of the PE list to the corresponding new value as determined at step 630 (for the CPE Parameters) or 670 (for the BPE Parameters).

Next, at step 710, the transmitting PE STA retrieves, for each mask-based PE parameter of the PE list, the new value of its corresponding shared mask as stored at step 640 (for the CPE Parameters) or 680 (for the BPE Parameters).

Next, at step 715, the transmitting PE STA encodes each mask-based PE parameter of the PE list with its local current value and its shared mask as retrieved at step 710. The encoding may be a mere XORing of the two values. The encoding result or output is referred to as “encoded PE parameter”.

Next, at step 720, the transmitting PE STA sets the transmitted PE parameter of each mask-based PE parameter of the PE list to the corresponding encoded PE parameter as determined at step 715.

The frame carrying all the transmitted PE parameters of the PE list that are obfuscated values is now ready. It is transmitted to the receiving PE STA at step 725.

At the reception side, when the receiving PE STA receives an intended frame (750), the receiving STA retrieves the list of PE parameters (called PE list) involved in the ERCM procedure.

Next, at step 755, the receiving PE STA retrieves, for each reset-based PE parameter, the current value of the PE parameter by extracting the transmitted PE parameter from the received frame.

Next, at step 760, the receiving PE STA retrieves, for each mask-based PE parameter, the new value of its corresponding shared mask as stored at step 640 (for the CPE Parameters) or 680 (for the BPE Parameters).

Next, at step 765, the receiving PE STA extracts, for each mask-based PE parameter, its corresponding transmitted value from the received frame.

Next, at step 770, the receiving PE STA decodes, for each mask-based PE parameter, the corresponding transmitted value as extracted at step 765. The decoding uses the shared mask retrieved at step 760 and the extracted transmitted value. The decoding may be a mere XORing of the two values. The decoding result or output corresponds to the current value of the mask-based PE parameter.

In some embodiments, the transmitted frame does not include some of the transmitted PE parameters corresponding to reset-based PE parameters, because the latter are known by the stations from the corresponding chunks in the CPE or BPE output obtained at step 620 or 660.

At this stage, the receiving PE STA has now knowledge of the values of all the PE parameters of the PE list. It can further process the frame based on these values.

To summarize, some embodiments of the invention focus on the computation procedure (based on a standardized PRF) used to obfuscate the values of the CPE parameters (e.g., MAC Address, SN, PN, TID) transmitted OTA and precises the CPE parameters involved in the computation procedure and the obfuscation method to be applied for each one.

For reminder, according to the specified 802.11bi requirements, when the OTA MAC address of the CPE Client is changed (R7), the CPE Client changes the transmitted SN and the scrambler seed on downlink and uplink (R9), the transmitted PN on downlink and uplink (R10), its AID (R11) and the transmitted TID (R30). The obfuscation consists in a change of the OTA values of theses CPE parameters at the start of each new epoch. For this, the “internal” value of the CPE parameter is either reset and replaced by a new uncorrelated and randomized one (reset-based) or obfuscated by an obfuscation operation as XOR, addition or an Offset (mask-based).

The computation procedure is based on a standardized PRF executed in parallel by the CPE Client and the CPE AP. It computes at once new reset values for each reset-based CPE parameter and new masks for each mask-based CPE parameter to be applied for the next epoch (n+1). Only one execution of the computation procedure is necessary for each epoch.

The computation procedure can be expressed as it:

$$CPE\_PARAM ( n + 1 ) = PRF - M / L ( K , A , B )$$

$$With M = 128 , 192 , 256 , 384 , 512 or 704$$

L the leftmost bits corresponding to the sum of the lengths of the CPE parameters
K: ERCM key (Private parameter), typically derived from PTK established during the authentication exchange
A: String “ERCM”
B: Temporal Reference

A standardized PRF (as specified in 12.7.1.2-IEEE Std 802.11-2020) takes 3 input parameters (K, A, B) with K as a key, A as a purpose label and B as a variable length string. More precisely, K is a an ERCM key (Private parameter), typically derived from PTK established during the authentication exchange, A is the String “ERCM” and B is a Temporal Reference.

The output CPE_PARAM corresponds to a sequence of pseudo random bits which is split into predetermined chunks, each chunk corresponding either to a new reset value for each reset-based CPE parameter or a new shared mask for each mask-based CPE parameter.

If the list of CPE parameters has been specified in 802.11bi requirements, the obfuscation procedure for each one has not been yet specified. Moreover, it has not yet taken into account that 802.11bi devices that support STA MAC address change while associated shall be MLD capable.

| CPE Parameters | Requirement |
|---|---|
| OTA MAC address | 7 |
| UL/DL SN | 9 |
| UL/DL Scrambler Seed | 9 |
| UL/DL PN | 10 |
| AID | 11 |
| UL/DL TID | 30 |

CPE parameters of the MLD CPE Client (MLD Level Parameters) and these of its affiliated non-AP STAs (Link Level Parameters) are generated with a single execution of a standardized PRF. A reset-based obfuscation procedure is applied for OTA MLD MAC address and OTA MAC addresses of each affiliated non-AP STAs, DL and UL Scrambler Seed and AID. A Per-Link mask-based obfuscation procedure (a different mask for each link) is applied SN, PN and TID.

As already said, only one execution of the computation procedure is necessary to obfuscate the list of CPE Parameters CPE_PARAM(n+1). The output CPE_PARAM(n+1) is split into predetermined chunks, each chunk corresponding either to a new reset value for each reset-based CPE parameter or a new shared mask for each mask-based CPE parameter and the new encoded parameter. Based on it, the obfuscated PE parameters are obfuscated. Based on the ordered list of the CPE parameters and the output CPE_PARAM(n+1) given in FIG. 3b, an example of a CPE Parameters Obfuscation Computation could be the following:

$$OTA MLD MAC ( n + 1 ) = CPE\_PARAM ( n + 1 ) [ 1 … 46 ]$$

$$OTA AID ( n + 1 ) = CPE\_PARAM ( n + 1 ) [ 47 … 62 ]$$

$$OTA MAC STA \# 1 ( n + 1 ) = CPE\_PARAM ( n + 1 ) [ 63 … 108 ]$$

$$OTA UL\_SN \#1 ( n + 1 ) = UL\_SN + CPE\_PARAM ( n + 1 ) [ 109 … 120 ]$$

$$OTA DL\_SN \#1 ( n + 1 ) = DL\_SN + CPE\_PARAM ( n + 1 ) [ 121 … 132 ]$$

$$OTA UL\_PN \#1 ( n + 1 ) = UL\_PN + CPE\_PARAM ( n + 1 ) [ 133 … 180 ]$$

$$OTA DL\_PN \#1 ( n + 1 ) = DL\_PN + CPE\_PARAM ( n + 1 ) [ 181 … 228 ]$$

$$OTA UL\_TID \#1 ( n + 1 ) = UL\_TID + CPE\_PARAM ( n + 1 ) [ 229 … 232 ]$$

$$OTA DL\_TID \#1 ( n + 1 ) = DL\_TID + CPE\_PARAM ( n + 1 ) [ 233 … 236 ]$$

$$OTA UL\_SS \#1 ( n + 1 ) = CPE\_PARAM ( n + 1 ) [ 237 … 243 ]$$

$$OTA DL\_SS \#1 ( n + 1 ) = CPE\_PARAM ( n + 1 ) [ 244 … 250 ]$$

$$OTA MAC STA \#2 ( n + 1 ) = CPE\_PARAM ( n + 1 ) [ 251 … 296 ]$$

$$OTA UL\_SN \#2 ( n + 1 ) = UL\_SN + CPE\_PARAM ( n + 1 ) [ 297 … 308 ]$$

$$OTA DL\_SN \#2 ( n + 1 ) = DL\_SN + CPE\_PARAM ( n + 1 ) [ 309 … 320 ]$$

$$OTA UL\_PN \#2 ( n + 1 ) = UL\_PN + CPE\_PARAM ( n + 1 ) [ 321 … 368 ]$$

$$OTA DL\_PN \#2 ( n + 1 ) = DL\_PN + CPE\_PARAM ( n + 1 ) [ 369 … 416 ]$$

$$OTA UL\_TID \#2 ( n + 1 ) = UL\_TID + CPE\_PARAM ( n + 1 ) [ 417 … 420 ]$$

$$OTA DL\_TID \#2 ( n + 1 ) = DL\_TID + CPE\_PARAM ( n + 1 ) [ 421 … 424 ]$$

$$OTA UL\_SS \#2 ( n + 1 ) = CPE\_PARAM ( n + 1 ) [ 425 … 431 ]$$

$$OTA DL\_SS \#2 ( n + 1 ) = CPE\_PARAM ( n + 1 ) [ 432 … 438 ]$$

where the X[k . . . l] corresponds to bits k to l of the bit string X starting from the left, and “+” is the addition operation (in a variant, the XOR operation may be used).

Consequently, the invention supports that MLD Level Parameters and Link Level Parameters are generated with a single execution of a standardized PRF and supports a per-link mask-based obfuscation procedure for SN, PN and TID.

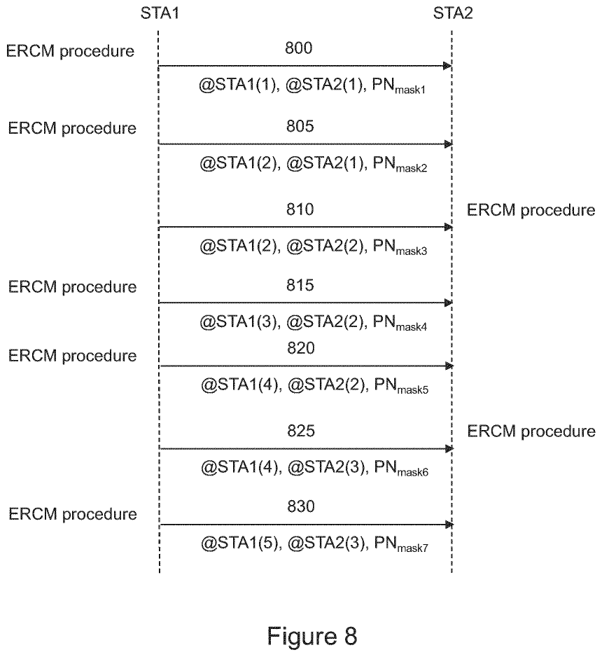

FIG. 8 illustrates, using frame exchanges, multiple obfuscations over time. For ease of illustration, only frames in one direction (from STA1 to STA2) are illustrated, although frames in both directions can coexist.

Also, a single frame is shown between each new ERCM procedure, although there are usually plenty of frames exchanged that are based on the current obfuscated PE parameter values. Frames 800 to 830 are transmitted with obfuscated PE parameters that partly change from one ERCM procedure to the other. For ease of illustration, only STA1's MAC address and the PN are shown as PE parameters for STA1, while STA2's MAC address and the PN are shown as PE parameters for STA2.

The labels “ERCM procedure” on the left side illustrate the multiple executions of such procedure for the PE parameters of STA1, while the labels “ERCM procedure” on the right side illustrate the multiple executions of such procedure for the PE parameters of STA2. The ERCM procedures for STA1 are Client ERCM procedures when STA1 is a non-AP station, or are BSS ERCM procedures when STA1 is an AP station. In the same way, the ERCM procedures for STA2 are Client ERCM procedures when STA2 is a non-AP station, or are BSS ERCM procedures when STA2 is an AP station.

In this example, the MAC addresses are reset-based PE parameters, while the PN is a mask-based PE parameter. @STA1(n) represents the value of STA1's MAC address after n ERCM procedures for this reset-based PE parameter. PN_{maskN} represents an encoded packet number masked with the N^{th} mask generated through ERCM procedures.

The Figure shows that each station performs multiple ERCM procedures for its own PE parameters but also performs multiple ERCM procedures for the PE parameters of the other station. Each station thus executes the shared function a second time (and more times) based on another current value of at least a second shared input (including the same or another shared generation parameter, e.g., updated MAC address, such as @STA1(1)), to obtain another reset-based PE parameter value (e.g., new MAC address) and another encoding parameter value (e.g., shared mask) for a mask-based PE parameter.

When the two ERCM procedures regard the same PE list (e.g., the first two procedures in the Figure relate to STA1's PE parameters), the other reset-based PE parameter value (in the second ERCM procedure) and the reset-based PE parameter value (in the first ERCM procedure) may relate to the same privacy parameter associated with one of the stations. In the example, @STA(1) is obtained through the first ERCM procedure, while @STA1(2) is obtained through the second ERCM procedure. Both obtained values related to the same reset-based PE parameter, here STA1's MAC address.

Similarly, the other encoding parameter value (e.g., mask2 in the second ERCM procedure) may be used to encode another value or decode another encoded value of the same mask-based PE parameter as in the first ERCM procedure (e.g., the PN as masked by Mask1 following the first ERCM procedure).

When the two ERCM procedures regard different PE lists (the second ERCM procedure regards STA1's PE parameters while the third ERCM procedure regards STA2's PE parameters), the other reset-based PE parameter value (in the third ERCM procedure, here STA2's MAC address) relates to a PE parameter associated with one of the stations (here STA2) and the reset-based PE parameter value (in the second ERCM procedures, here STA1's MAC address) relates to a PE parameter associated with the other station (here STA1).

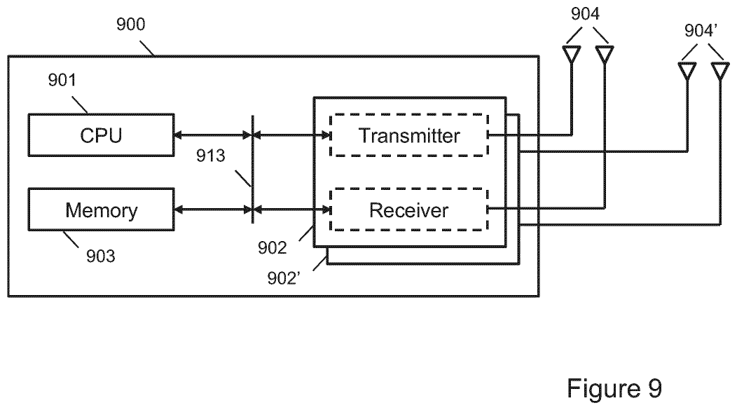

FIG. 9 schematically illustrates a communication device 900, typically any of the stations of FIG. 1, of a wireless network, configured to implement at least one embodiment of the present invention. The communication device 900 may preferably be a device such as a micro-computer, a workstation or a light portable device. The communication device 700 may comprise a communication bus 813 to which may be connected:
a central processing unit 901, such as a processor, denoted CPU;
a memory 903, denoted MEM, for storing an executable code of methods or steps of the methods according to embodiments of the invention as well as the registers adapted to record variables and parameters necessary for implementing the methods; and
at least two communication interfaces 902 and 902′ connected to the wireless communication network, for example a communication network according to one of the IEEE 802.11 family of standards, via transmitting and receiving antennas 904 and 904′, respectively.

Preferably the communication bus 913 may provide communication and interoperability between the various elements included in the communication device 900 or connected to it. The representation of the bus is not limiting and in particular the central processing unit is operable to communicate instructions to any element of the communication device 900 directly or by means of another element of the communication device 900.

The executable code may be stored in a memory that may either be read only, a hard disk or on a removable digital medium such as for example a disk. According to an optional variant, the executable code of the programs can be received by means of the communication network, via the interface 902 or 902′, in order to be stored in the memory 903 of the communication device 900 before being executed.

In an embodiment, the device 900 may be a programmable apparatus which uses software to implement embodiments of the invention. However, alternatively, embodiments of the present invention may be implemented, totally or in partially, in hardware (for example, in the form of an Application Specific Integrated Circuit or ASIC).

Embodiment(s) of the present invention can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard-disk, a random-access memory (RAM), a read only memory (ROM), a storage of distributed computing systems, an optical disk (such as a compact disc (CD), digital versatile disc (DVD), etc.), a flash memory device, a memory card, and the like.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

1. A method of communication in wireless network, comprising, at a first station:
executing a function, shared with a second station, with a current value of at least one shared input, to obtain a result value;
obtaining a first privacy parameter value as a first chunk of the result value and an encoding parameter value as a second chunk of the result value;
encoding a second privacy parameter value using the encoding parameter value; and
transmitting to the second station a frame comprising the first privacy parameter value and the encoded second privacy parameter value.

2. A method of communication in wireless network, at a second station, comprising:
executing a function, shared with a first station, with a current value of at least one shared input, to obtain a result value;
obtaining a first privacy parameter value as a first chunk of the result value and an encoding parameter value as a second chunk of the result value;
receiving from the first station a frame comprising the first privacy parameter value and an encoded second privacy parameter value;
decoding, using the encoding parameter value, the encoded second privacy parameter value to obtain a second privacy parameter value.

3. The method of claim 1, wherein encoding includes masking, such as XORing, the second privacy parameter with the encoding parameter value.

4. The method of claim 1, wherein the encoding parameter value is a binary mask to be XORed with the second privacy parameter value for encoding.

5. The method of claim 1, wherein the same encoding parameter value is used to encode another privacy parameter value than the second privacy parameter value.

6. The method of claim 1, wherein multiple encoding parameter values are obtained as multiple chunks of the result value, and encoding the second privacy parameter value includes selecting one of the multiple encoding parameter values that is assigned to a link on which the frame is to be transmitted and encoding the second privacy parameter value using the selected encoding parameter value.

7. The method of claim 2, wherein multiple encoding parameter values are obtained as multiple chunks of the result value, and decoding the encoded second privacy parameter value includes selecting one of the multiple encoding parameter values that is assigned to a link on which the frame is received and decoding the encoded second privacy parameter value using the selected encoding parameter value.

8. The method of claim 1, further comprising obtaining multiple first privacy parameter values and/or multiple encoding parameter values as multiple chunks of the result value.

9. The method of claim 8, wherein the frame comprises the multiple first privacy parameter values and/or multiple second privacy parameter values encoded using the multiple encoding parameter values respectively.

10. The method of claim 1, wherein the chunks are disjoint within the result value.

11. The method of claim 1, further comprising executing the shared function a second time based on another current value of at least a second shared input, to obtain another first privacy parameter value and another encoding parameter value.

12. The method of claim 11, further comprising one or more of the following features:
the other first privacy parameter value and the first privacy parameter value relate to the same privacy parameter associated with one of the stations,
the other encoding parameter value is used to encode another value or decode another encoded value of the same privacy parameter as the second privacy parameter value,
the other current value of the second shared input includes the first privacy parameter value,
the at least one second shared input is the same as the at least one shared input,
the at least one second shared input is the same as the at least one shared input that includes a MAC address of on of the stations, and
the other first privacy parameter value relates to a privacy parameter associated with one of the stations and the first privacy parameter value relates to a privacy parameter associated with the other station.

13-17. (canceled)

18. The method of claim 1, wherein the at least one shared input includes a key shared with the second station and a generation parameter shared with the second station and varying over time.

19. The method of claim 1, wherein the first privacy parameter or parameters are one or more from:
one or more Extended Unique Identifiers, EUIs, of the stations,
one or more MAC addresses of the stations,
a MAC address of a Multi-Link Device, MLD, to which one of the stations is affiliated,
a sequence number used by the stations to uniquely identify a new MSDU, A-MSDU, or MMPDU,
an uplink sequence number used by the stations to uniquely identify a new uplink MSDU, A-MSDU, or MMPDU,
a downlink sequence number used by the stations to uniquely identify a new unicast downlink MSDU, A-MSDU, or MMPDU,
a group sequence number used by the stations to uniquely identify a new broadcast or multicast downlink MSDU, A-MSDU, or MMPDU,
an association identifier, AID, of one of the stations to uniquely identify the one station within a BSS of the stations,
a scrambler seed used by the stations to initialize a local scrambler scrambling transmit data and/or descrambling receive data,
an uplink scrambler seed used by the stations to initialize a local scrambler scrambling transmit uplink data and/or descrambling receive uplink data,
a downlink scrambler seed used by the stations to initialize a local scrambler scrambling transmit unicast downlink data and/or descrambling receive unicast downlink data,
a group scrambler seed used by the stations to initialize a local scrambler scrambling transmit broadcast or multicast downlink data and/or descrambling receive broadcast or multicast downlink data,
a beacon interval defining the time interval between two consecutive target beacon transmission times, TBTTs,
a BSS color used as a numerical identifier of a BSS of the stations.

20. The method of claim 1, wherein the second privacy parameter or parameters are one or more from:
a sequence number used by the stations to uniquely identify a new MSDU, A-MSDU, or MMPDU,
an uplink sequence number used by the stations to uniquely identify a new uplink MSDU, A-MSDU, or MMPDU,
a downlink sequence number used by the stations to uniquely identify a new unicast downlink MSDU, A-MSDU, or MMPDU,
a group sequence number used by the stations to uniquely identify a new broadcast or multicast downlink MSDU, A-MSDU, or MMPDU,
a packet number used by the stations to uniquely identify a new frame,
an uplink packet number used by the stations to uniquely identify a new uplink frame,
a downlink packet number used by the stations to uniquely identify a new unicast downlink frame,
a group packet number used by the stations to uniquely identify a new broadcast or multicast downlink frame,
an uplink Traffic Identifier, TID, used by the stations to provide Quality of Services to an uplink frame,
a downlink Traffic Identifier, TID, used by the stations to provide Quality of Services to a downlink frame,
a beacon interval defining the time interval between two consecutive target beacon transmission times, TBTTs,
a Timing Synchronization Function timer used to synchronize stations within a BSS of the stations.

21. The method of claim 1, wherein the first privacy parameter value is a MAC address of the first station and the frame comprises a transmitter address field set to the first privacy parameter value and a receiver address field set to a MAC address of the second station, or
the first privacy parameter value is a MAC address of the second station and the frame comprises a receiver address field set to the first privacy parameter value and a transmitter address field set to a MAC address of the first station.

22. (canceled)

23. The method of claim 1, wherein the first station is a non-AP station and the second station is an AP station, or the first station is an AP station and the second station is a non-AP station.

24. (canceled)

25. A first communication device comprising at least one processing circuit, wherein the
at least one processing circuit causes the first communication device to perform operations comprising:
executing a function, shared with a second communication device, with a current value of at least one shared input, to obtain a result value; wherein a first privacy parameter value is made of a first chunk of the result value and an encoding parameter value is made of a second chunk of the result value;
encoding a second privacy parameter value using the encoding parameter value; and
transmitting to the second communication device a frame comprising the first privacy parameter value and the encoded second privacy parameter value.

26. (canceled)

27. A second communication device comprising at least one processing circuit, wherein the
second communication device is caused, by the at least one processing circuit, to perform operations comprising:
executing a function, shared with a first communication device, with a current value of at least one shared input, to obtain a result value; wherein a first privacy parameter value is made of a first chunk of the result value and an encoding parameter value is made of a second chunk of the result value;
receiving from the first communication device a frame comprising the first privacy parameter value and an encoded second privacy parameter value;
decoding, using the encoding parameter value, the encoded second privacy parameter value to obtain a second privacy parameter value.

28. A non-transitory computer-readable medium storing a program for causing a computer to execute the communication method according to claim 1.

29. A non-transitory computer-readable medium storing a program for causing a computer to execute the communication method according to claim 2.
